(19) United States
(12) Patent Application Publication
(10) Pub. No.: US 2007/0222832 A1
(43) Pub. Date: Sep. 27, 2007

(54) Ink tank assembly for inkjet system, and image forming apparatus

(75) Inventor: Yasuko Yahiro, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/723,905

(22) Filed: Mar. 22, 2007

(30) Foreign Application Priority Data
Mar. 22, 2006 (JP) 2006-079415

(51) Int. Cl. B41J 2/175

(52) U.S. Cl. 347/85

(57) ABSTRACT

The ink tank assembly for an inkjet system includes: a tank which contains an ink; and an air/liquid separating member which is arranged in the tank. The ink has a surface tension higher than a surface free energy of the air/liquid separating member. The ink is a dispersion including a liquid and suspended particles of an insoluble material which is insoluble to the liquid. The insoluble material has a frequency of particles having diameters not smaller than 150 nm, of not more than 2% by volume in the insoluble material.

### BACKGROUND OF THE INVENTION

1. Field of the Invention

The present invention relates to an ink tank assembly for an inkjet system and an image forming apparatus provided with the ink tank assembly, and more particularly, to improvements for preventing deterioration of ink ejection characteristics during prolonged use of an ink cartridge having an air/liquid separating member, and preventing decline in the accuracy of the ink depositing positions caused by deterioration in the ink ejection characteristics.

2. Description of the Related Art

In broad terms, the following three methods have been proposed thus far as ink supply methods for an image forming apparatus, such as an inkjet recording apparatus.

The first proposal is a method in which a recording head and an ink tank are connected by means of a connecting tube, or the like, and problems of wasted space created by the connecting tube, variation in the ink supply pressure caused by external disturbance due to the connecting tube, or infiltration of air from the connecting tube, have been pointed out in relation to this method.

The second method is a tank-on-carriage method, which is satisfactory from the viewpoint of pressure stability, but which limits on the weight of the cartridge and places a burden on the user with respect to cartridge replacement.

The third method is a “pit stop” method, in which ink is supplied to an ink tank of an ink cartridge, from a separately provided main tank, by periodically connecting the ink tank with the main tank (see, for example, Japanese Patent Application Publication No. 9-234881).

Merits of this pit stop method are pressure stability inside the liquid chamber during ejection and the absence of limits on the ink tank capacity, and application of this method is anticipated in small-scale portable printing devices, or wide-format image forming apparatuses, which are subject to high image quality requirements and are expected to consume large volumes of ink.

A desirable ink cartridge structure for the pit stop method is one using an air/liquid separating member inside an ink tank that stores ink to be supplied to the recording head. However, various problems have been identified, namely, a problem with refilling caused by adherence of ink to the air/liquid separating member (see, for example, Japanese Patent Application Publication Nos. 2002-240323 and 2003-246077), and deterioration in the deformation of the air/liquid separating member due to increase in the pressure required for refilling as a result of adherence of ink (see, Japanese Patent Application Publication No. 2003-246075), and countermeasures for these problems have been undertaken. Consequently, the problems relating to the air/liquid separating member have been eliminated, and repeated ink filling has become possible. Furthermore, countermeasures for the long-term preservation stability of the dye ink based on the composition of the ink have also been discovered (Japanese Patent Application Publication No. 2004-331751).

However, a phenomenon of deterioration in ink ejection characteristics with prolonged use has been newly identified in cases where an ink cartridge provided with an ink tank having an air/liquid separating member is used. More specifically, the accuracy of the depositing positions of the ink declines as a result of deterioration in the ink ejection characteristics. Ultimately, nozzle blockages occur.

Standard inks used in inkjet recording apparatuses have a surfactant additive, thereby ensuring ink ejection characteristics (see, for example, Japanese Patent Application Publication No. 2002-240323). However, in the case of the “pit stop” type of ink supply system, for example, due to the relationship between the surfactant and the air/liquid separating member arranged in the ink tank, it may not be possible to add any surfactant to the ink, or if it is added, the addable amount is severely limited. Therefore, compared to ink used in the first and second ink supply methods described above, the dispersibility of the insoluble material declines due to the decline in the amount of surfactant, and hence the ink ejection characteristics become highly liable to deteriorate. The deterioration in the ink ejection characteristics is not avoidable even in the above-described method disclosed in Japanese Patent Application Publication No. 2004-331751, and this problem has been considered as inherent in the dye ink.

Japanese Patent Application Publication No. 2002-240323 discloses that the ink contains 1 wt % (percent by weight) or less of surfactant, and the ink has a surface tension not less than 28 mN/m and not more than 50 mN/m, while the ink tank has a surface tension not less than 35 mN/m and not more than 50 mN/m. By means of this composition, it is possible to prevent the formation of a meniscus inside the air/liquid separating member, thus providing a beneficial effect in that the ink can be supplied smoothly.

However, although Japanese Patent Application Publication No. 2002-240323 provides beneficial effects in relation to the supply of ink, no beneficial effects in improving the ejection characteristics of the ink are observed.

### SUMMARY OF THE INVENTION

The present invention has been contrived in view of these circumstances, an object thereof being to provide an ink tank assembly for the inkjet system and an image forming apparatus provided with this ink tank assembly, being an ink tank assembly for the inkjet system that has an air/liquid separating member arranged inside the tank storing ink, in which stable ink ejection characteristics can be maintained over a long period of time.

In order to attain the aforementioned object, the present invention is directed to an ink tank assembly for an inkjet system, comprising: a tank which contains an ink; and an air/liquid separating member which is arranged in the tank, wherein: the ink has a surface tension higher than a surface free energy of the air/liquid separating member; the ink is a dispersion including a liquid and suspended particles of an insoluble material which is insoluble to the liquid; and the insoluble material has a frequency of particles having diameters not smaller than 150 nm, of not more than 2% by volume in the insoluble material.

According to this aspect of the present invention, even under conditions where decline in the ink ejection characteristics is unavoidable with prolonged use, because either it is impossible to add surfactant to the ink stored in the ink tank, or if surfactant is added, the addable amount is severely limited, due to the relationship between the surfactant and the air/liquid separating member provided in the ink tank, by using, as an ink, a dispersion comprising an insoluble material having insoluble characteristics dispersed in a solvent, for the ink stored in the ink tank, and by using the ink which has a frequency of 2% or less by volume of particles having diameters of 150 nm or larger in the particle diameter distribution of the insoluble material, then it is possible to improve markedly the ink ejection characteristics over long-term use of the inkjet system. Consequently, it is possible to suppress decline in the accuracy of the depositing positions of the ink over long-term use of the inkjet system.

Therefore, even if the air/liquid separating member is provided in the ink tank which supplies the ink to the recording head, as in the case of a “pit stop” type of ink supply method, it is still possible to maintain the ink ejection characteristics stably, over long-term use of the inkjet system.

Here, the condition that “the frequency of particles having diameters not smaller than 150 nm is not more than 2% by volume in the insoluble material” means that, taking the total volume of the insoluble material having the particle diameter distribution to be 100%, the ratio of the volume of the particles of the insoluble material having the particle diameters of 150 nm or lager is 2% or less with respect to the total volume of the insoluble material.

Preferably, the insoluble material has a frequency of particles having diameters not smaller than 100 nm, of not more than 2% by volume in the insoluble material.

According to this aspect of the present invention, it is possible to increase further the dispersibility of the insoluble material, and it is possible to maintain the ink ejection characteristics stably, over long-term use of the inkjet system, more effectively.

Preferably, a concentration of the insoluble material is not less than 0.5% by weight and not more than 20% by weight in the ink.

It is desirable that the colorant concentration should be not less than 0.5 wt % in order to obtain good optical density. Moreover, if the concentration of the insoluble material contained in the ink exceeds 20 wt %, then the viscosity of the ink exceeds 20 mPa·s, and hence ink ejection tends to be difficult, even in the initial state immediately after manufacture of the ink. Furthermore, if used over a long period of time, there is a greater tendency for ink ejection characteristics to deteriorate with use in the inkjet system over a long period, compared to cases where the concentration of insoluble material is not more than 20 wt %. A more desirable range of the concentration of the insoluble material is not less than 1 wt % and not more than 15 wt % in the ink.

Preferably, the insoluble material includes pigment particles.

The pigment is a typical example of the insoluble material contained in the ink.

Preferably, a grafted chain layer is introduced in a surface of each of the pigment particles.

According to this aspect of the present invention, in addition to enhancing dispersibility by forming the pigment (insoluble material) contained in the ink into micro-particles, it is also possible to enhance the dispersibility by means of the pigment particles themselves.

It is also preferable that the insoluble material includes polymer particles.

The polymer particles correspond another typical example of the insoluble material contained in the ink.

Preferably, the polymer particles are made of a polymer which has a film forming function.

According to this aspect of the present invention, the polymer added to the ink as a quality enhancer in the form of the insoluble material is either a polymer that has the action of increasing the force of adhesion of the coloring material to the recording medium, or a polymer that has a film forming function. Since these polymers are insoluble with respect to the solvent and can cause a decline in the dispersibility of the ink, then the present invention can be applied beneficially to such polymers.

Preferably, the polymer particles are made of a block polymer compound including polyethylene oxide.

According to this aspect of the present invention, in addition to enhancing dispersibility by forming the polymer (insoluble material) contained in the ink into micro-particles, it is also possible to enhance the dispersibility by means of the polymer micro-particles themselves.

It is possible that the insoluble material includes a mixture of a plurality of types of particles which are each made of a plurality of types of material.

It is also possible that the insoluble material includes a type of composite particles which is made of a plurality of types of material.

The beneficial effects of the present invention are not limited to one type of insoluble material alone.

In order to attain the aforementioned object, the present invention is also directed to an image forming apparatus, comprising the above-described ink tank assembly.

According to this aspect of the present invention, it is possible to maintain the ink ejection characteristics stably, over long-term use of the image forming apparatus.

Preferably, the image forming apparatus further comprises: a recording head to which the ink is supplied from the ink tank assembly, the recording head outputting an image according to a printing signal; and an ink absorbing member which is arranged in the tank and holds the ink by means of capillary action, wherein: the tank has an air connection port which connects an interior of the tank with air; and the air/liquid separating member is arranged in the tank at a position dividing the air connection port from the interior of the tank.

According to this aspect of the present invention, the ink supply path from the ink tank to the recording head is appropriately formed.

Preferably, the image forming apparatus further comprises a main tank, wherein: the tank has an ink inlet port through which the tank is connected to the main tank to receive the ink; and a pit stop type ink supply device which supplies the ink from the main tank to the tank by performing suction through the air connection port.

The ink tank used with the pit stop type ink supply device is a typical example of the ink tank provided with the air/liquid separating member.

According to the ink tank assembly for the inkjet system and the image forming apparatus of the present invention, even if the ink tank for supplying the ink to the recording head is provided with the air/liquid separating member as in the case of the “pit stop” type of ink supply method, it is still possible to maintain the ink ejection characteristics stably, over a long period of time.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic drawing of the general composition of an inkjet recording apparatus according to an embodiment of the present invention;

FIG. 2 is a schematic drawing of an ink cartridge in the inkjet recording apparatus;

FIG. 3 is a plan diagram for describing an ink supply mechanism based on a pit stop system;

FIG. 4 is a side view diagram for describing the ink supply mechanism based on the pit stop system;

FIG. 5 is a cross-sectional diagram of a recording head in the inkjet recording apparatus;

FIGS. 6A to 6D are diagrams showing the particle diameter distribution of insoluble material in respective inks in the practical example 1;

FIG. 7 is an illustrative diagram of a method of measuring the displacement of depositing positions;

FIG. 8 is a graph showing the relationship between the frequency of particles of insoluble material having diameters of 150 nm or lager, and the displacement of the depositing positions;

FIGS. 9A to 9D are tables showing the results of the initial measurement of the displacement of the depositing positions;

FIGS. 10A and 10B are tables showing the results of the measurement of the displacement of the depositing positions, after long-term storage; and

FIG. 11 is a graph showing the relationship between the conductivity of the ink and the frequency of particles of insoluble material having diameters of 150 nm or lager.

### DETAILED DESCRIPTION OF THE PREFERRED EMBODIMENTS

An embodiment of the present invention is described below with reference to an inkjet recording apparatus 10 having an ink supply mechanism based on the “pit stop” method, which is a representative embodiment of an image forming apparatus provided with an ink tank assembly according the embodiment of the present invention. In the present embodiment, the ink tank assembly according to the embodiment of the present invention is mounted on an ink cartridge, on which a recording head and other members are unitedly arranged.

### General Composition of Inkjet Recording Apparatus

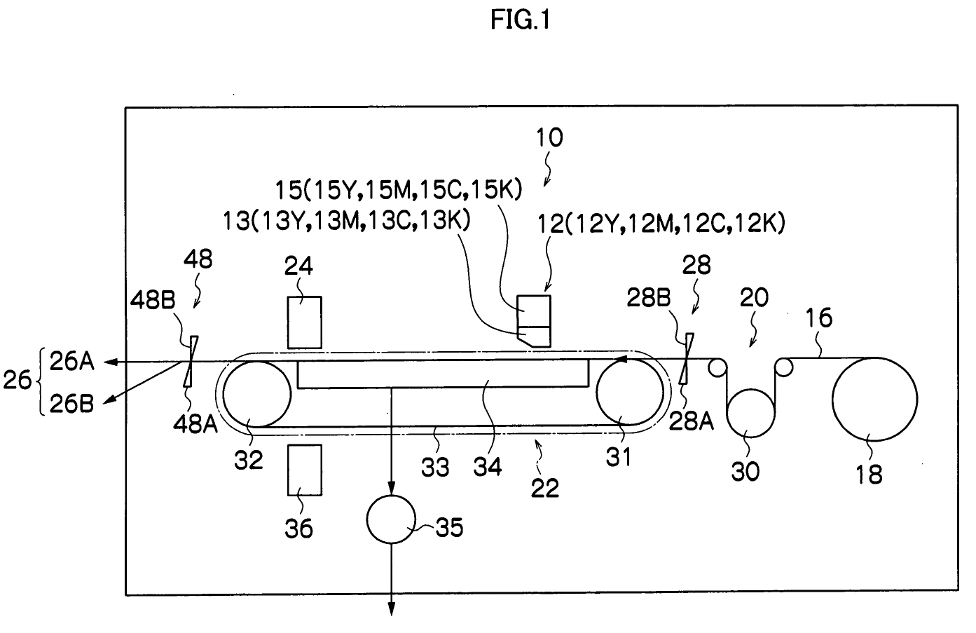

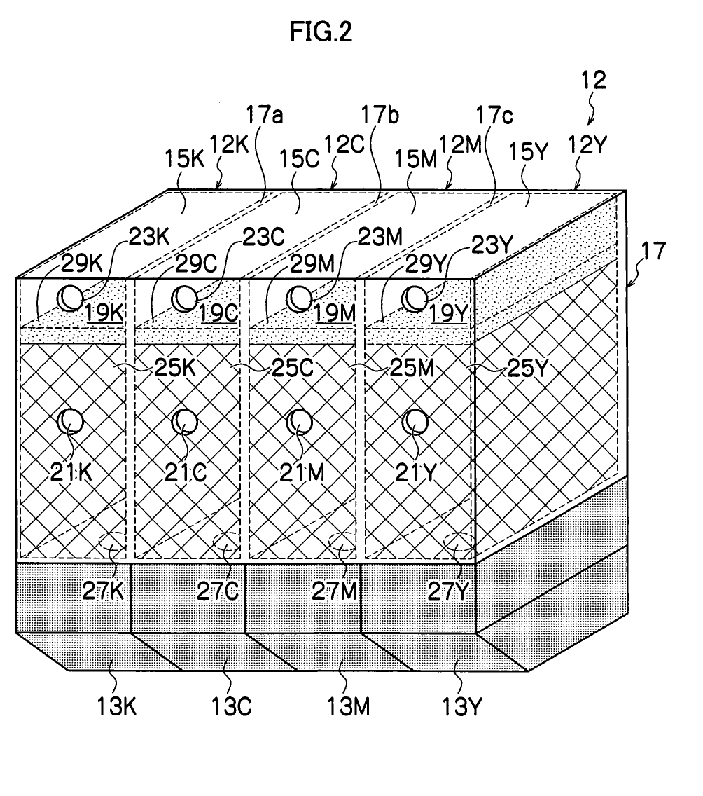

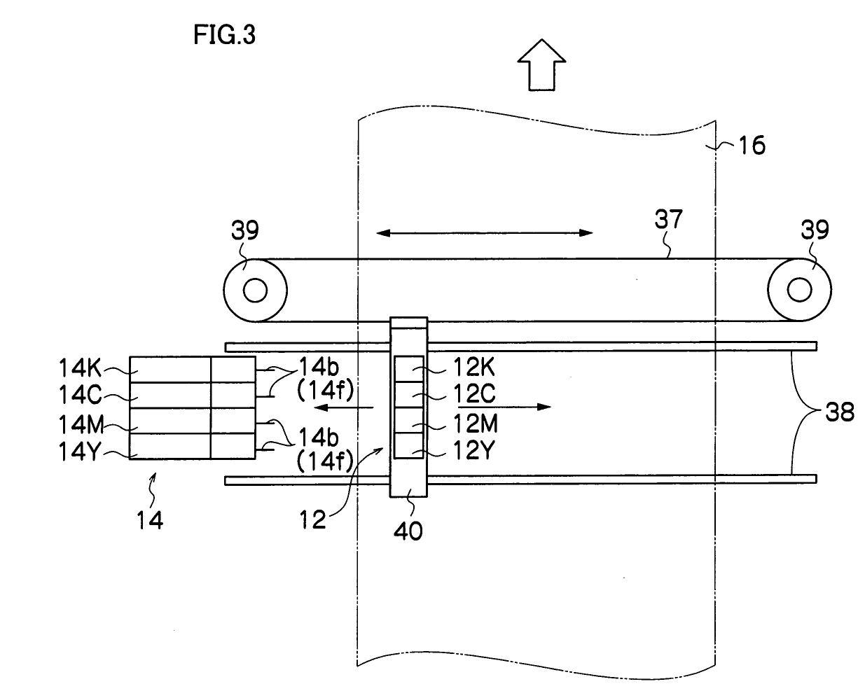

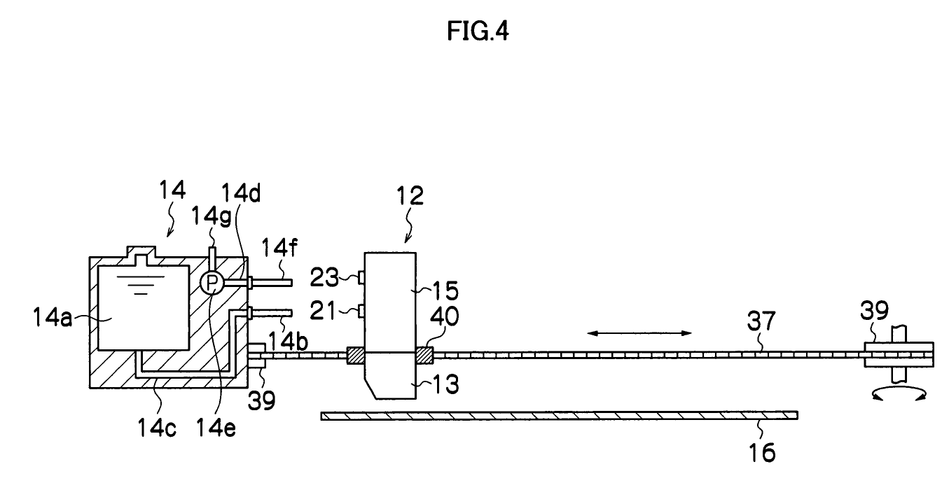

FIG. 1 is a schematic drawing of the general composition of an inkjet recording apparatus 10 according to the present embodiment; FIG. 2 is a schematic drawing of the ink cartridge; and FIGS. 3 and 4 are illustrative diagrams of the ink supply mechanism based on the pit stop method.

As shown in FIG. 1, this inkjet recording apparatus 10 includes: ink cartridges 12Y, 12M, 12C and 12K (which may be referred collectively to as the ink cartridge 12) provided to correspond to respective inks (recording liquids) of yellow (Y), magenta (M), cyan (C) and black (K); main tanks 14Y, 14M, 14C and 14K (which may be referred collectively to as the main tank 14) (see FIGS. 3 and 4), which store the respective inks for supply to the ink cartridge 12; a paper supply unit 18, which supplies recording medium (recording paper) 16; a decurling unit 20, which removes curl from the recording medium 16; a suction belt conveyance unit 22 (movement device), which is disposed opposing the nozzle face (ink ejection face) of recording heads 13Y, 13M, 13C and 13K (which may be referred collectively to as the recording head 13) on the ink cartridge 12, and conveys the recording medium 16 while keeping the recording medium 16 flat; a print determination unit 24, which reads in the print results obtained by the ink cartridge 12; and a paper output unit 26, which outputs printed recording paper (printed matter) to the exterior.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording media can be used, it is preferable that an information recording medium such as a bar code and a wireless tag containing information about the type of medium is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording medium 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording medium 16 has a curl in which the surface on which the print is to be made is slightly round outward.

In the case of the configuration in which roll paper is used as the recording medium 16, a cutter (first cutter) 28 is provided as shown in FIG. 1, and the continuous paper is cut into a desired size by the cutter 28. The cutter 28 has a stationary blade 28A, whose length is not less than the width of the conveyor pathway of the recording medium 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut papers are used, the cutter 28 is not required.

The decurled and cut recording medium 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the ink cartridge 12 and the sensor disposed face of the print determination unit 24 forms a horizontal plane (flat plane).

The belt 33 has a width that is greater than the width of the recording medium 16, and a plurality of suction apertures (not shown) are formed on the belt surface. A suction chamber 34 is disposed in a position facing the sensor disposed face of the print determination unit 24 and the nozzle face of the ink cartridge 12 on the interior side of the belt 33, which is set around the rollers 31 and 32, as shown in FIG. 1. The suction chamber 34 provides suction with a fan 35 to generate a negative pressure, and the recording medium 16 is held on the belt 33 by suction.

The belt 33 is driven in the counterclockwise direction in FIG. 1 by the motive force of a motor being transmitted to at least one of the rollers 31 and 32, which the belt 33 is set around, and the recording medium 16 held on the belt 33 is conveyed from right to left in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can have a roller nip conveyance mechanism, in which the recording paper 16 is pinched and conveyed with nip rollers, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

The print determination unit 24 has an image sensor which is a device for capturing an image of the droplet ejection result of the ink cartridge 12, and functions as a device to check for ejection abnormalities, such as blockages of the nozzles, on the basis of the droplet ejection results read in by the image sensor. The print determination unit 24 according to the present example is constituted by a line sensor having photoreceptor elements of at least a greater width than the image recording width that can be recorded onto the recording medium 16. This line sensor has a color separation line CCD sensor including a red (R) photoreceptor row composed of photoelectric transducing elements (pixels) arranged in a line provided with an R filter, a green (G) photoreceptor row provided with a G filter, and a blue (B) photoreceptor row provided with a B filter. Instead of a line sensor, it is also possible to use an area sensor composed of photoelectric transducing elements which are arranged two-dimensionally.

The print determination unit 24 reads a test pattern (or actual image) printed by the ink cartridges 12Y, 12M, 12C and 12K for the respective colors, and determines the ejection of each recording head. The ejection determination includes the presence of ejection, measurement of the dot size, measurement of the dot depositing position, and the like.

The printed matter generated in this manner is outputted from the paper output unit 26. The target print (i.e., the result of printing the target image) and the test print are preferably output separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, the paper output unit 26A for the target prints is provided with a sorter for collecting prints according to print orders.

### Composition of Ink Cartridge

As shown in FIG. 2, the ink cartridge 12 (12Y, 12M, 12C, 12K) is integrally composed of the recording head 13 (13Y, 13M, 13C, 13K) corresponding to the respective inks and the ink tank 15 (15Y, 15M, 15C, 15K) supplying the inks to the recording head 13. The respective ink tanks 15Y, 15M, 15C and 15K are formed by dividing one box member 17 by means of three dividing walls 17a, 17b and 17c.

Ink inlet ports 21Y, 21M, 21C and 21K (which may be referred collectively to as the ink inlet port 21) for taking in the inks from the main tank 14 by connecting to the respective supply tanks 14Y, 14M, 14C and 14K in the main tank 14 are formed in the central positions of the side wall faces of the respective ink tanks 15Y, 15M, 15C and 15K. The ink inlet port 21 is provided with a sealing mechanism, such as a dual valve mechanism or a slidable opening and closing mechanism (not shown), in order that the ink tank 15 is not connected to the outside air when supply pin 14b of the main tank 14 (see FIGS. 3 and 4) is inserted into the inlet port 21.

Air connection ports 23Y, 23M, 23C and 23K (which may be referred collectively to as the air connection port 23), which connect the interior of the ink tanks 15Y, 15M, 15C and 15K with the outside air, are opened in upper positions on the same walls of the ink tanks 15Y, 15M, 15C and 15K as the walls where the ink inlet ports 21Y, 21M, 21C and 21K are formed, respectively. In FIG. 2, the air connection ports 23Y, 23M, 23C and 23K are formed for the respective ink tanks 15Y, 15M, 15C and 15K, but it is also possible to form a single air connection port 23 on the upper face of the box body 17 and to connect the ink tanks 15Y, 15M, 15C and 15K to the single air connection port 23 by means of connection channels (not shown).

Ink supply ports 27Y, 27M, 27C and 27K (which may be referred collectively to as the ink supply port 27) for supplying the inks to the respective recording heads 13Y, 13M, 13C and 13K are opened in the bottom faces of the ink tanks 15Y, 15M, 15C and 15K, respectively. Ink absorbing members 25Y, 25M, 25C and 25K (which may be referred collectively to as the ink absorbing member 25) are filled in the ink tanks 15Y, 15M, 15C and 15K. Hence, the ink to be supplied to the recording head 13 is held inside the ink tank 15, in an absorbed state in the ink absorbing member 25. For the ink absorbing member 25, it is desirable to use a high-density foam material, such as urethane, polypropylene, polyethylene, polytetrafluoroethylene, cellutose, or the like. Apart from these materials, it is also possible to use a porous member made of polytetrafluoroethylene (PTFE), ceramic, porcelain, metal (for example, an aluminum porous member), or the like. It is desirable to use a hydrophilic material for the surface of the ink absorbing member 25, or to provide a hydrophilizing treatment on the surface of the ink absorbing member 25. The hydrophilizing treatment on the surface of the ink absorbing member 25 has the beneficial effect of hindering the introduction of air bubbles when ink is supplied into the cartridge.

Air/liquid separating members 29Y, 29M, 29C and 29K (which may be referred collectively to as the air/liquid separating member 29) are arranged on the upper sides of the respective ink absorbing members 25Y, 25M, 25C and 25K. The air connection ports 23Y, 23M, 23C and 23K are in connection with head space sections 19Y, 19M, 19C and 19K on the upper sides of the air/liquid separating members 29Y, 29M, 29C and 29K, respectively.

### Composition of Main Tank

As shown in FIGS. 3 and 4, the main tank 14 is constituted by the integrally formed main tanks 14Y, 14M, 14C and 14K, which store the inks of the respective colors, and the inks are supplied from the main tanks 14Y, 14M, 14C and 14K to the respective ink tanks 15Y, 15M, 15C and 15K in the ink cartridge 12, by means of the “pit stop” method. In FIG. 3, the main tanks 14Y, 14M, 14C and 14K are depicted as having the same size, but it is preferable that the main tank 14K for black ink, which has a higher use frequency, is larger than the main tanks 14Y, 14M and 14C for the other colors.

Moreover, as revealed by FIG. 4 showing an internal cross-section of the main tank 14, a supply channel 14c connects from the bottom section of a tank container 14a to the supply pin 14b, which projects from the side face of the main tank 14. Furthermore, a suction channel 14d is formed from the upper part of the side face of the tank container 14a, to a suction pin 14f, which projects from a position above the supply pin 14b on the side face of the main tank 14 (the same face as the supply pin 14b). A suction pump 14e is arranged at an intermediate point of the suction channel 14d. An exhaust port 14g of the suction pump 14e is opened on the outer side of the main tank 14.

The front end sections of the supply pin 14b and the suction pin 14f are provided with valves (not shown), and have a structure that prevents the inks from leaking in a state where the supply pin 14b and the suction pin 14f are not inserted in the ink inlet port 21 and the air connection port 23 of the ink cartridge 12. The residual ink amount in each of the tank containers 14a of the respective inks in the main tank 14 is monitored by a residual amount detector (not shown), and an alarm device (display device, or warning sound generating device) is provided which generates a suitable notification if the residual amount of ink has become low. Moreover, a mechanism for preventing incorrect loading of the wrong ink is also provided.

### Composition of Ink Supply Mechanism Based on Pit Stop Method

As shown in FIGS. 3 and 4, the ink cartridge 12 is mounted on a carriage 40, which is supported slidably by a pair of guide shafts 38 disposed in parallel with the breadthways direction of the recording medium 16. A pair of timing pulleys 39 are arranged in the breadthways direction of the recording medium 16, and an endless timing belt 37 is suspended about this pair of timing pulleys 39, and one end of the carriage 40 is connected to the timing belt 37. By causing a drive apparatus (not shown) for driving rotation of a drive pulley of the pair of timing pulleys 39 to rotate in the forward and reverse directions on the basis of a printing signal, the ink cartridge 12 mounted on the carriage 40 is moved reciprocally forth and back (in a shuttle movement) in the breadthways direction (through the width of the print region) of the recording medium 16, and the inks are ejected from the recording heads 13Y, 13M, 13C and 13K on the basis of the printing signal. Accordingly, printing is performed onto the recording medium 16 conveyed on the recording path from the paper supply unit 18.

The above-described main tank 14 is arranged at one end position of the pair of guide shafts 38 (namely, a position outside the width of the printing region). If, for example, the black ink inside the ink tank 15K of the ink cartridge 12 has become low and it is necessary to perform refilling from the main tank 14K, then the ink cartridge 12 is moved to an ink refilling position, which is at the position of the main tank 14, and the supply pin 14b and the suction pin 14f of the main tank 14K are inserted into the ink inlet port 21 and the air connection port 23 of the ink tank 15K, respectively. In this state, by driving the pump 14e of the main tank 14K, sucking air through the air connection port 23K and thereby reducing the pressure inside the ink tank 15K, black ink in the tank 14a of the main tank 14K is sucked and supplied through the supply pin 14b of the main tank 14K into the ink tank 15K through the ink inlet port 21K. The supply operation to the ink tanks of the other colors is performed in a similar manner.

Although the configuration of YMCK colors of the inks is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta or dark-colored inks such as dark yellow are added. Furthermore, there are no particular restrictions of the sequence in which the heads of respective colors are arranged.

### Structure of Recording Head

Next, the structure of the recording heads is described. The recording heads 13Y, 13M, 13C and 13K arranged in the ink cartridge 12 have a common structure, and a representative example (hereinafter referred to as the “recording head 13”) is described below.

As shown in FIG. 5, the recording head 13 according to the present embodiment is constituted by ink chamber units (liquid droplet ejection elements), each including a nozzle 51 forming an ejection port for ink droplets and a pressure chamber 52 corresponding to the nozzle 51, and the like. The pressure chamber 52 provided corresponding to the nozzle 51 is approximately square-shaped in plan view, and the nozzle 51 and a supply port 54 are provided respectively at corners on a diagonal of the pressure chamber 52.

The nozzle face (ink ejection face) 50A of the recording head 13 is constituted by a nozzle plate 60, in which the nozzles (nozzle orifices) 51 are formed. The pressure chamber 52 is connected to a flow channel 55 through the supply port 54. The flow channel 55 is connected to the ink tank 15 through the ink supply port 27 described above. The ink supplied from the ink tank 15 is supplied to the pressure chambers 52 through the flow channel 55.

An actuator 58 provided with an individual electrode 57 is joined to a diaphragm (common electrode) 56, which forms the upper face of each pressure chamber 52, and the actuator 58 is deformed when a drive voltage is supplied to the individual electrode 57, thereby causing the volume of the pressure chamber 52 to change and hence causing the ink to be ejected from the nozzle 51 due to the resulting pressure variation. A piezoelectric element composed of a piezoelectric body such as lead zirconate titanate (PZT) is suitable as the actuator 58. When the ink has been ejected, new ink is supplied to the pressure chamber 52 from the ink tank 15 through the flow channel 55 and the ink supply port 27.

Moreover, in the present embodiment, the method is employed where an ink droplet is ejected by means of the deformation of the actuator 58, which is, typically, a piezoelectric element, but in implementing the embodiment of the present invention, there are no particular restrictions on the method used for ejecting ink, and instead of the piezo jet method, it is also possible to apply various other types of methods, such as a thermal jet method, where the ink is heated and bubbles are caused to form therein, by means of a heat generating body, such as a heater, ink droplets being ejected by means of the pressure generated by these bubbles.

In the inkjet recording apparatus 10 having the composition described above, it is necessary to provide the air/liquid separating member 29 inside the ink tank 15 of the ink cartridge 12, but if the air/liquid separating member 29 is provided, then it becomes impossible to add a surfactant to the ink in order to improve the dispersibility of the insoluble material (such as inorganic pigment) which is not soluble in the ink solvent, or even if such a surfactant can be added, then the addable amount is severely limited. Consequently, ink ejection characteristics deteriorate with long-term use, and the accuracy of the ink depositing positions declines as a result of this deterioration of the ink ejection characteristics. Ultimately, nozzle blockages occur.

Therefore, in the embodiment of the present invention, as described below, by adjusting the particle size distribution of the insoluble material contained in the ink, and the relationship between the surface tension of the ink and the surface free energy of the air/liquid separating member 29, as well as adjusting the conductivity of the ink to a prescribed value, the ink ejection characteristics are stabilized over a long period of time, even in cases where no surfactant, or only a small amount of surfactant, is added to the ink.

### Description of Ink

According to the embodiment of the present invention, the ink stored in the ink tank 15 of the ink cartridge 12 satisfies at least the following two conditions.

The first condition is that a dispersion composed of a solvent and dispersed particles of a material insoluble to the solvent is used as the ink, and the dispersed particles have a frequency of particles having diameters of 150 nm or larger of 2 vol % (percent by volume) or less in the particle size distribution of the insoluble material.

The second condition is that the surface tension of the ink is comparatively high in relation to the surface free energy of the air/liquid separating member 29. In this case, it is possible to adjust the surface tension of the ink in order to satisfy the above-mentioned relationship, or alternatively, it is possible to adjust the surface free energy of the air/liquid separating member 29 in order to satisfy the above-mentioned relationship.

In this way, by storing, in the ink tank 15, the ink that has a suitably fine particle state of the insoluble material contained in the ink, and that satisfies a suitable relationship between the surface tension of the ink and the surface free energy of the air/liquid separating member 29, and by supplying such the ink to the recording head 13, then it is possible to maintain stable ink ejection characteristics from the recording head 13 over a long period of time, even in cases where no surfactant, or only a small amount of surfactant, is added to the ink.

More desirably, the frequency of particles having diameters of 100 nm or larger in the particle size distribution of the insoluble material, is 2 vol % or less.

Here, the surface free energy of the air/liquid separating member is determined by the Van Oss method. Although the porous material is cut to shape for use in an actual air/liquid separating member, this measurement method is applied to the same material in the form of a resin sheet. The angle of contact is measured using pure water, diidomethane and ethylene glycol, the variance component γS, the polar component γP, and the hydrogen bond component γH in the surface free energy are calculated, and the total surface free energy γ=γS+γP+γH can be determined accordingly. It is suitable to use the solid-liquid interface analyzing apparatus “DropMaster 500” manufactured by Kyowa Interface Science Co., Ltd. The speed at which the ink is absorbed by the porous material is not sufficiently high to affect the measurement, and therefore the angle of contact can be measured accurately.

The surface tension of the ink can be measured suitably by using the surface tensionometer “CBVP-Z” manufactured by Kyowa Interface Science Co., Ltd.

Desirably, the concentration of the insoluble material contained in the ink is not less than 0.5 wt % and not more than 20 wt %, and more desirably, it is not less than 1 wt % and not more than 15 wt %. This is because, in the case of an inorganic pigment, an organic pigment or polymer particles, it is necessary for the ink to contain 0.5 wt % or more of the solvent-insoluble material in order to obtain a certain level of image density, and more desirably, the ink should contain 1 wt % or more of the solvent-insoluble material. With respect to the upper limit, on the other hand, the higher the concentration of the insoluble material, the easier it becomes to obtain a high optical density, which is desirable, but increasing the concentration of particles means that the ink viscosity also rises, and this has a detrimental effect on the ink ejection characteristics. The insoluble material concentration of 20 wt % is the upper limit for achieving stable ink ejection characteristics, and more desirably, the concentration of insoluble material should be 15 wt % or less.

Moreover, it is desirable to use an insoluble material having an average particle size not less than 20 nm and not more than 100 nm. In the case of a pigment, if the particles are smaller than 20 nm, then fading of the coloring material is liable to become a problem, whereas if the average particle size is greater than 100 nm, then the surface scattering of the particles is liable to affect, leading to clouded color tones. Moreover, the color reproduction range also tends to narrow.

Furthermore, in order to maintain stable ink ejection characteristics over a long period of time, it is desirable to improve the dispersibility of the insoluble material by suitably adjusting the conductivity of the ink. More specifically, the adjustment of the conductivity of the ink is desirable in terms of enhancing the dispersibility of the insoluble material to adjust the ink conductivity to the range of 0.1 S/m to 1 S/m. Moreover, in a case where the ink conductivity is adjusted to a range of 0.1 S/m to 1 S/m, it is desirable that the zeta potential of the insoluble material is +5 mV to +90 mV, and furthermore, the ink pH is adjusted to 2 to 7. Alternatively, in a case where the ink conductivity is adjusted to a range of 0.1 S/m to 1 S/m, it is desirable that the zeta potential of the insoluble material is −5 mV to −90 mV, and furthermore, the ink pH is adjusted to 7 to 12.

Consequently, in the inkjet recording apparatus 10, by using the ink having the characteristics described above, even if droplet ejection is performed over a long period of time from the recording head 13, the ink ejection characteristics are not liable to deteriorate, and therefore, decline in the accuracy of the ink depositing positions and the occurrence of nozzle blockages are suppressed.

### Insoluble Material Contained in Ink

As the insoluble material contained in the ink, pigment micro-particles are used, for example, any one of C.I. pigment yellow 12, 13, 17, 55, 74, 97, 120, 128, 151, 155 and 180, can be desirably used. Moreover, it is also desirable to use C.I. pigment red 122, C.I. pigment violet 19, C.I. pigment red 57:1, 146, C.I. pigment blue 15:3, or the like. In this case, desirably, a grafted chain layer is introduced to the surface of the pigment micro-particles. As one example of the grafted chain layer pigment, it is possible to cite a pigment in which a portion of the pigment particle is coated with a polyhydroxyalkanoate as represented by the following formula:

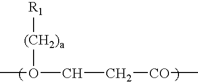

where R₁: hydrogen atom H, and a is an integer from 0 to 10; or

### R₁: halogen atom, and a is an integer from 1 to 10; or

### R₁: carboxyl group or salt thereof, and a is an integer from 1 to 10; or

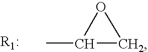

and a is an integer from 1 to 7.

As a desirable example of the pigment used in the embodiment of the present invention, it is possible to cite a pigment of a self dispersing type. The self-dispersing type of pigment is a pigment in which a plurality of hydrophilic functional groups and/or salts of same are bonded directly, or indirectly by means of an alkyl group, an alkyl ether group, an aryl group, or the like, to the surface of the pigment particle, in such a manner that the pigment particles can be dispersed in an aqueous solvent without a dispersant. The pigment of the self dispersing type can be dispersed in an aqueous solvent even without using any dispersant. An ink containing the self-dispersing type of pigment as a colorant does not require the inclusion of a dispersant such as that described above, which is included in order to cause dispersion of a normal pigment. Consequently, there is virtually none of the foaming caused by reduction in the anti-foaming properties that may arise when a dispersant is present, and hence an ink having excellent ejection stability can be manufactured easily.

Possible examples of a dispersibility imparting group that bonds to the surface of the self-dispersing type of pigment particle are —COOH, —CO, —OH, —SO₃H, —PO₃H₂ and quaternary ammonium, and salts of these, and these are manufactured by subjecting the pigment starting material to physical processing or chemical processing, in such a manner that the aforementioned dispersibility imparting group or an active species having the aforementioned dispersibility imparting group is bonded (grafted) to the surface of the pigment particle. Vacuum plasma processing, for instance, may be cited as an example of physical processing. Furthermore, examples of methods of the chemical processing are a wet oxidation method which oxidizes the surface of the pigment particle by means of an oxidant, in water, and a method which bonds a carboxylic group via a phenyl group, by bonding a p-aminobenzoic acid to the surface of the pigment particle.

In the embodiment of the present invention, from the viewpoint of good coloration characteristics, it is desirable to use a self-dispersing type of pigment which has been surface treated by means of an oxidation process based on a hypohalous acid and/or hypohalous acid salt, or an oxidation process based on ozone.

It is also possible to use a commercially available self-dispersing type of pigment, such as Microjet CW-1 (trade name; manufactured by Orient Chemical Industries Ltd.), or CAB-O-JET 200 and CAB-O-JET 300 (trade names; manufactured by Cabot Corporation), or the like.

Desirably, the content ratio of the self-dispersing type of pigment in the ink is in the range of 0.5 wt % to 20 wt %.

Furthermore, it is also possible to cite a micro-capsulated pigment as a desirable example of a pigment contained in the ink. A micro-capsulated pigment is one in which the pigment particle is coated with a resin.

There are no particular restrictions on the resin used for a micro-capsulated pigment, but desirably, it should be a compound of high molecular weight which has a self-dispersing capability and solubility in water, and contains an anionic group (acidic). Generally, it is desirable that the resin should have a number average molecular weight in the approximate range of 1,000 to 100,000, and especially desirably, in the approximate range of 3,000 to 50,000. Moreover, desirably, this resin can dissolved in an organic solvent to form a solution. By limiting the number average molecular weight of the resin to this range, it is possible to make the resin display satisfactory functions as a covering film for the pigment particle, or as a coating film in the ink composition.

The resin may itself have a self-dispersing capability or solubility, or these functions may be added or introduced. Consequently, for example, it is possible to use a resin having an introduced carboxyl group, sulfonic acid group, or phosphonic acid group or another anionic group, by neutralizing with an organic amine or alkali metal. Moreover, it is also possible to use a resin into which one or two or more anionic groups of the same type or different types have been introduced. In the embodiment of the present invention, it is desirable to use a resin which has been neutralized by means of a salt and which contains an introduced carboxyl group.

In this way, in the embodiment of the present invention, it is desirable to use a resin in the form of a salt of an alkali metal or organic amine. If a resin is used in the form of a salt, then it is possible to provide an ink having excellent redispersibility and reliability. Specific examples of a salt of a resin and an alkali metal include: lithium, sodium and potassium salts; desirably, alkali metal salts of sodium hydroxide, potassium hydroxide, lithium hydroxide, and more desirably, a salt of potassium hydroxide. Furthermore specific examples of a salt of a resin and an organic amine include: salts of volatile amine compounds, such as ammonia, triethyl amine, tributyl amine, dimethyl ethanol amine, diisopropanol amine, or morpholine; and salts of non-volatile high-boiling-point organic amines, such as diethanol amine or triethanol amine.

Specific examples of resins for micro-capsulated pigment include: polyvinyl materials, such as vinyl chloride, vinyl acetate, polyvinyl alcohol, or polyvinyl butyral; polyester materials, such as an alkyd resin or a phthalate resin; amino materials such as a melamine resin, a melamine formaldehyde resin, an amino alkyd co-condensated resin, a urea resin, or a uric acid resin; or a thermoplastic or thermosetting or denatured acrylic, epoxy, polyurethane, polyester, polyamide, unsaturated polyester, phenol, silicone, or fluorine-based polymer compound, or copolymers or mixtures of these, or other materials containing an anionic group.

Before using the resin for the micro-capsulated pigment, a reactive/active group, such as a glycidil group, an isocyanate group, a hydroxyl group or an α,β-ethylenic unsaturated double bond (vinyl group) may be attached as a pendant group to the actual resin, or a cross-linking agent having a reactive/active group, for example, a photocuring agent, such as a melamine resin, a urethane resin, an epoxy resin, an ethylenic unsaturated monomer or oligomer, or the like, may be mixed with the resin. By subjecting the resin to processing of this kind, it is possible further to improve the properties of the resin, such as the solvent resistance and durability of the pigment covering, and a further benefit is obtained in terms of improved film strength after the ink has formed a coating film on the recording medium.

Of the resins described above, an anionic acrylic resin can be obtained, for example, by polymerizing an acrylic monomer having an anionic group (hereinafter, called an “anionic group-containing acrylic monomer) and, according to requirements, another monomer which can be copolymerized with this monomer, in a solvent. The anionic group-containing acrylic monomer may be, for example, an acrylic monomer having one or more anionic group selected from a group including a carboxyl group, a sulfonic acid group and a phosphonic group, and of these, an acrylic monomer having a carboxyl group is particularly desirable.

Specific examples of an acrylic monomer having a carboxylic group are: acrylic acid, methacrylic acid, crotonic acid, ethacrylic acid, propyl acrylic acid, isopropyl acrylic acid, itaconic acid, fumaric acid, or the like. Of these, acrylic acid or methacrylic acid is desirable. Specific examples of acrylic monomers having a sulfonic acid group include: sulfoethyl methacrylate, butyl acrylamide sulfonic acid, and the like. Specific examples of acrylic monomers having a phosphonic group include: phosphoethyl methacrylate, and the like.

Specific examples of other monomers which can be copolymerized with an anionic group-containing acrylic monomer include: (meth)acrylic acid esters, such as methyl acrylate, ethyl acrylate, isopropyl acrylate, n-propyl acrylate, n-butyl acrylate, t-butyl acrylate, 2-ethyl hexyl acrylate, n-octyl acrylate, lauryl acrylate, benzyl acrylate, methyl methacrylate, ethyl methacrylate, isopropyl methacrylate, n-propyl methacrylate, n-butyl methacrylate, isobutyl methacrylate, t-butyl methacrylate, 2-ethyl hexyl methacrylate, n-octyl methacrylate, lauryl methacrylate, stearyl methacrylate, tridecyl methacrylate, benzyl methacrylate, or the like; an adduct reaction product of an oil or fatty acid and a (meth)acrylic acid ester monomer having an oxirane structure, such as an adduct reaction product of stearic acid and glycidyl methacrylate; an adduct reaction product of (meth)acrylic acid and an oxirane compound containing an alkyl group having three or more carbon atoms; a styrene monomer, such as styrene, α-methyl styrene, o-methyl styrene, m-methyl styrene, p-methyl styrene, p-tert-butyl styrene, or the like; an itaconic acid ester, such as benzyl itaconate; a malleinic acid ester, such as dimethyl malleinate; a fumaric acid ester, such as dimethyl fumarate; acrilonitrile, methacrylonitrile, vinyl acetate, isobornyl acrylate, isobornyl methacrylate, aminoethyl acrylate, aminopropyl acrylate, methyl aminoethyl acrylate, methyl aminopropyl acrylate, ethyl aminoethyl acrylate, ethyl aminopropyl acrylate, aminoethyl amide acrylate, aminopropyl amide acrylate, methyl aminoethyl amide acrylate, methyl aminopropyl amide acrylate, ethyl aminoethyl amide acrylate, ethyl aminopropyl amide acrylate, amide methacrylate, aminoethyl methacrylate, aminopropyl methacrylate, methyl aminoethyl methacrylate, methyl aminopropyl methacrylate, ethyl aminoethyl methacrylate, ethyl aminopropyl methacrylate, aminoethyl amide methacrylate, aminopropyl amide methacrylate, methyl aminoethyl amide methacrylate, methyl aminopropyl amide methacrylate, ethyl aminoethyl amide methacrylate, ethyl aminopropyl amide methacrylate, hydroxymethyl acrylate, 2-hydroxyethyl acrylate, 2-hydroxypropyl acrylate, hydroxymethyl methacrylate, 2-hydroxyethyl methacrylate, 2-hydroxypropyl methacrylate, N-methylol acryl amide, allyl alcohol, or the like.

Possible examples of a monomer containing a cross-linking functional group include those described below. A polymerizable monomer having a block isocyanate group can be manufactured readily by adding and reacting a commonly known blocking agent, with a polymerizable monomer having an isocyanate group, such as 2-methacryol oxyethyl isocyanate, or the like. Alternatively, it may be manufactured readily by adding and reacting a compound having an isocyanate group and a block isocyanate group, with a vinyl copolymer having a hydroxyl group and carboxyl group as described above. The compound having an isocyanate group and a block isocyanate group can be obtained easily by adding and reacting a commonly known blocking agent, with a diisocyanate compound, at a rate of 1:1 by mol ratio.

The monomer having an epoxy group may be, for example, glycidyl(meth)acrylate, a (meth)acrylate monomer having an alicyclic epoxy group, or the like. Possible examples of a monomer having a 1,3-dioxolane-2-one-4-yl group, include: 1,3-dioxolane-2-one-4-yl methyl (meth)acrylate, 1,3-dioxolane-2-one-4-yl methyl vinyl ether, and the like.

Possible examples of a polymerization initiator are: peroxide compounds, such as t-butyl peroxybenzoate, di-t-butyl peroxide, cumene perhydroxide, acetyl peroxide, benzoyl peroxide, lauroyl peroxide, or the like; azo compounds, such as azo bis-isobutyl nitrile, azo bis-2,4-dimethyl valeronitrile, azo bis-cyclohexane carbonitrile; and the like.

As examples of a solvent used when polymerizing an anionic group-containing acrylic monomer and, according to requirements, another monomer which can be copolymerized with these monomers, it is possible to cite: an aliphatic hydrocarbon-based solvent such as hexane or mineral spirit; an aromatic hydrocarbon-based solvent such as benzene, toluene or xylene; an ester-based solvent such as butyl acetate; a ketone-based solvent, such as methyl ethyl ketone or isobutyl methyl ketone; an alcohol-based solvent, such as methanol, ethanol, butanol or isopropyl alcohol; or an aprotic polar solvent, such as dimethyl formamide, dimethyl sulfoxide, N-methylpyrrolidone or pyridine. It is also possible to use two or more types of these solvents, in combination.

In the embodiment of the present invention, desirably, the resin which coats the pigment particle also contains a curing agent and/or a polymer compound. More desirably, the pigment is also coated with a curing agent and/or polymer compound. The curing agent or polymer compound has the action of curing the covering shell of the colorant, and increasing the strength of the coating film when it is used in an ink.

Specific examples of a curing agent which can be used in the embodiment of the present invention are: melamine resin, amino resins, such as benzoguanamine resin or urea resin, phenol resins, such as trimethylol phenol, or a condensate of same; polyisocyanates, such as tetramethylene diisocyanate (TDI), diphenyl methane diisocyanate (MDI), hexamethylene diisocyanate (HDI), naphthalene diisocyanate (NDI), isophorone diisocyanate (IPDI), xylylene diisocyanate (XDI), and denatured isocyanates or block isocyanates of these, or the like; amines, such as an aliphatic amine, an aromatic amine, N-methyl piperazine, triethanol amine, morpholin, dialkyl aminoethanol, benzyl dimethyl amine, or the like; acid anhydrides, such as a polycarboxylic acid, anhydrous phthalic acid, anhydrous malleinic acid, anhydrous hexahydrophthalic acid, anhydrous pyromellitic acid, anhydrous benzophenone tetracarboxylic acid, ethylene glycol bis-trimellitate, or the like; a bisphenol A type epoxy resin, a phenol type epoxy resin, glycidyl methacrylate copolymer, a glycidyl ester resin of carboxylic acid, an epoxy compound such as an alicyclic epoxy; alcohols, such as polyether polyol, polybutadiene glycol, polycaprolactone polyol, tris-hydroxyethyl isocyanate (THEIC), or the like; a polyvinyl compound, which is a compound containing an unsaturated group used for radical curing or UV curing by means of a peroxide, or for electron beam curing; polyaryl compounds, vinyl compounds, such as a reaction product of a glycol or polyol and acrylic acid or methacrylic acid; and the like.

Furthermore, according to requirements, it is desirable to add a light-activated initiator, a polymerization initiator, or a catalyst, in order to promote curing. As examples of a light-activated initiator, it is possible to cite benzoins, anthraquinones, benzophenones, sulfurous compounds, dimethyl benzyl ketal, or the like, but the initiator is not limited to these examples. Possible examples of a polymerization initiator are: peroxide compounds, such as t-butyl peroxybenzoate, di-t-butyl peroxide, cumene perhydroxide, acetyl peroxide, benzoyl peroxide, lauroyl peroxide, or the like; azo compounds, such as azo bis-isobutyl nitrile, azo bis-2,4-dimethyl valeronitrile, azo bis-cyclohexane carbonitrile; and the like. Possible examples of a catalyst are a Co compound, a Pb compound, and the like.

There are no particular restrictions of the polymer compound which can be used in the embodiment of the present invention, provided that it has a number average molecular weight of 1,000 or above, but from the viewpoint of the strength of the ink film and the manufacturability of the pigment covering, a compound having a number average molecular weight in the range of 3,000 to 100,000 is desirable.

There are no particular restrictions on the type of polymer compound used, and possible examples include: polyvinyl materials, such as vinyl chloride, vinyl acetate, polyvinyl alcohol, or polyvinyl butyral; polyester materials, such as an alkyd resin or a phthalate resin; amino materials such as a melamine resin, a melamine formaldehyde resin, an amino alkyd co-condensated resin, a urea resin, or a uric acid resin; or a thermoplastic or thermosetting or denatured acrylic, epoxy, polyurethane, polyester, polyamide, unsaturated polyester, phenol, silicone, or fluorine-based polymer compound, or copolymers or mixtures of these, or the like.

The micro-capsulated pigment can be manufactured from the components described above, using a conventional physical or chemical method. In a desirable mode of the present invention, the pigment is manufactured by means of the method described in Japanese Patent Application Publication No. 9-151342, Japanese Patent Application Publication No. 10-140065, Japanese Patent Application Publication No. 11-209672, Japanese Patent Application Publication No. 11-172180, Japanese Patent Application Publication No. 10-25440, or Japanese Patent Application Publication No. 11-43636. The methods of manufacture disclosed in these publications are outlined below.

Japanese Patent Application Publication No. 9-151342 and Japanese Patent Application Publication No. 10-140065 describe a phase inversion method and an acid precipitation method.

a) Phase Inversion Method

In the embodiment of the present invention, the phase inversion method basically means a self-dispersion method (phase inversion emulsification method) by which a fused mixture of a pigment and a resin having a self-dispersing capability or solubility are dispersed in water. Furthermore, this fused mixture may include the curing agent or polymer compound described above. Here, this fused mixture may be in either a mixed and undissolved state, or a mixed and dissolved state, or both of these states.

b) Acid Precipitation Method

In the embodiment of the present invention, the acid precipitation method is a method for manufacturing a micro-capsulated pigment by preparing an aqueous cake comprising resin and pigment and neutralizing one part or all of an anionic group contained in the resin in the aqueous cake.

More specifically, the acid precipitation method comprises: (1) a step of creating a resin gel by dispersing a resin and a pigment in an alkali aqueous medium and carrying out heat treatment as required; (2) a step of making the resin hydrophobic and thus fixing the resin strongly to the pigment, by making the pH neutral or acidic; (3) a step of obtaining an aqueous cake by carrying out filtering and washing, according to requirements; (4) a step of neutralizing all or a portion of the anionic group contained in the resin in the aqueous cake, by using a basic compound, and then redispersing in an aqueous medium; and (5) a step of achieving gelation of the resin by carrying out heat treatment, according to requirements. The specific methods of manufacture based on phase inversion and acid precipitation described above are the same as those disclosed in Japanese Patent Application Publication No. 9-151342 and Japanese Patent Application Publication No. 10-140065.

Japanese Patent Application Publication No. 11-209672 and Japanese Patent Application Publication No. 11-172180 disclose a method of manufacturing a colorant. In general terms, this method of manufacture basically comprises the following manufacturing steps.

(1) A step of mixing and neutralizing a resin having an anionic group, or a solution in which this resin is dissolved in an organic solvent, with a basic compound; (2) a step of obtaining a pigment dispersion solution by creating a suspension solution by mixing pigment with the mixed solution from (1), and then dispersing the pigment by means of a dispersion machine, or the like; (3) a step of evaporating and removing solvent, as required; (4) a step of coating the pigment with the resin having an anionic group, by adding an acidic compound and causing the resin having an anionic group to precipitate; (5) a step of filtering and washing, according to requirements; and (6) a step of neutralizing the anionic group of the resin having an anionic group by adding a basic compound, and dispersing in an aqueous medium to yield an aqueous dispersion. More specific methods of manufacture may be similar to those disclosed in Japanese Patent Application Publication No. 11-2096722 and Japanese Patent Application Publication No. 11-172180.

When forming an image, from the viewpoint of imparting glossiness and waterproofing characteristics, and improving weatherproofing, it is possible to combine use of a polymer latex compound. With regard to the timing at which the latex compound is deposited onto the receiving medium, it may be deposited before, after or at the same time as depositing the coloring material, and therefore it may be added to the image receiving paper or the ink, or alternatively, it may be used in the form of an independent polymer latex liquid. More specifically, it is desirable to use a method as described in Japanese Patent Application Publication No. 2002-166638, Japanese Patent Application Publication No. 2002-121440, Japanese Patent Application Publication No. 2002-154201, Japanese Patent Application Publication No. 2002-144696, or Japanese Patent Application Publication No. 2002-080759.

The description thus far relates to a case where the insoluble material is a pigment, but the insoluble material may also be polymer micro-particles.

In a case where the insoluble material is constituted by polymer micro-particles, the polymer micro-particles having a coloring material adhesion force enhancing function and a film coating forming function are applicable. In this case, desirably, the polymer micro-particles are a block polymer compound containing polyethylene oxide. One example of a block polymer compound containing polyethylene oxide is represented by the following formula:

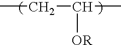

where R: —X—COOH; or

### R: —X—COOR; or

### R: —X—COOM,

where X: linear, or branched, or cyclic alkylene, having 1 to 20 carbon atoms;

### R: alkyl group; and

### M: monovalent or multivalent cation.

The insoluble material contained in the ink is not limited to pigment micro-particles or polymer micro-particles as described above, and all materials which are insoluble in the solvent are applicable. Furthermore, the insoluble material contained in the ink is not limited to being one type of material, and it is also possible to include insoluble materials of a plurality of types.

### Solvent Used in Ink

As the solvent used in the ink, it is possible to use a mixed liquid having water as a main component, to which a water-miscible organic solvent is added as desired. Examples of the water-miscible organic solvent include: an alcohol (for example, methanol, ethanol, propanol, isopropanol, butanol, isobutanol, sec-butanol, t-butanol, pentanol, hexanol, cyclohexanol, or benzyl alcohol); a polyhydric alcohol (for example, ethylene glycol, diethylene glycol, triethylene glycol, polyethylene glycol, propylene glycol, dipropylene glycol, polypropylene glycol, butylene glycol, hexanediol, pentanediol, glycerine, hexanetriol, or thiodiglycol); a glycol derivative (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, or ethylene glycol monophenyl ether); an amine (for example, ethanolamine, diethanolamine, triethanolamine, N-methyl diethanolamine, N-ethyl diethanolamine, morpholine, N-ethyl morpholine, ethylene diamine, diethylene triamine, triethylene tetramine, polyethylene imine, or tetramethyl propylene diamine); and other polar solvents (for example, formamide, N,N-dimethyl formamide, N,N-dimethyl acetamide, dimethyl sulfoxide, sulfolane, 2-pyrrolidone, N-methyl-2-pyrrolidone, N-vinyl-2-pyrrolidone, 2-oxazolidinone, 1,3-dimethyl-2-imidazolidinone, acetonitrile, or acetone). It is also possible to use two or more types of the water-miscible organic solvents described above.

### Manufacture of Ink

The ink for the inkjet system can be manufactured by dissolving and/or distributing a coloring material in an oleophilic medium or aqueous medium. If an aqueous medium is used, then according to requirements, another additive is included, within a range which does not impair the beneficial effects of the embodiment of the present invention.

The other additive may be, for example, a commonly known additive, such as an anti-drying agent (moisturizing agent), a permeation promoter, an ultraviolet absorber, an anti-fading agent, an antibacterial agent, a pH adjuster, a surface tension adjuster, an emulsion stabilizer, a preservative, an antifoaming agent, a viscosity adjuster, a dispersant, a dispersion stabilizer, an anti-rusting agent, a chelating agent, or the like. In the case of a water-soluble ink, these various additives are added directly to the ink liquid. In a case where an oil-soluble pigment is used in the form of a dispersion, then generally, additives are generally added to the pigment dispersion after preparation of the dispersion.

The anti-drying agent is preferably used at the ink spray ports of the nozzles in the inkjet system, and it prevents blockages caused by drying of the ink for the inkjet system. Desirably, the anti-drying agent is a water-soluble organic solvent having a lower vapor pressure than water. Specific examples of this agent include: polyhydric alcohols, such as ethylene glycol, propylene glycol, diethylene glycol, polyethylene glycol, thiodiglycol, dithioglycol, 2-methyl-1,3-propane diol, 1,2,6-hexane triol, an acetylene glycol derivative, glycerine, trimethylol propane, or the like; a lower alkyl ether of a polyhydric alcohol, such as an ethyelene glycol monomethyl (or ethyl) ether, a diethylene glycol monomethyl (or ethyl) ether, or a triethylene glycol monomethyl (or butyl) ether; a heterocyclic ring, such as 2-pyrrolidone, N-methyl-2-pyrrolidone, 1,3-dimethyl-2-imidazolidinone, or N-ethyl morpholin, or the like; a sulfurous compound, such as sulfolane, dimethyl sulfoxide, 3-sulfolene, or the like, a polyfunctional compound, such as diacetone alcohol, diethanol amine, or the like; or a urea derivative. Of these, a polyhydric alcohol, such as glycerine or diethylene glycol is most desirable. The anti-drying agents described above may be used independently, or two or more types of anti-drying agent may be used together in combination. Desirably, the content of these anti-drying agents in the ink is 10 wt % to 50 wt %.

Furthermore, preferably, a permeation promoter is used in order to make the ink permeate more readily into the recording medium (printing paper). Specific examples of a permeation promoter which can be used preferably in the embodiment of the present invention are: an alcohol, such as ethanol, isopropanol, butanol, di(tri)ethyelene glycol monobutyl ether, 1,2-hexanediol, or the like, or sodium lauryl sulfate, sodium oleate, a non-ionic surface active agent, or the like. These permeation promoters display sufficient effects when contained at a rate of 5 wt % to 30 wt % in the ink composition. Moreover, the permeation promoter is desirably added in an amount which prevents print bleeding or print-through effects.

An ultraviolet absorber is used in order to improve image conservation. For the ultraviolet absorber, it is possible to use: a benzotriazole compound as described in Japanese Patent Application Publication No. 58-185677, Japanese Patent Application Publication No. 61-190537, Japanese Patent Application Publication No. 2-782, Japanese Patent Application Publication No. 5-197075, Japanese Patent Application Publication No. 9-34057, or the like; a benzophenone compound as described in Japanese Patent Application Publication No. 46-2784, Japanese Patent Application Publication No. 5-194483, U.S. Pat. No. 3,214,463, or the like; a cinnamic acid compound as described in Japanese Patent Application Publication No. 48-30492, Japanese Patent Application Publication No. 56-21141, Japanese Patent Application Publication No. 10-88106, or the like; a triazine compound as described in Japanese Patent Application Publication No. 4-298503, Japanese Patent Application Publication No. 8-53427, Japanese Patent Application Publication No. 8-239368, Japanese Patent Application Publication No. 10-182621, Japanese Patent Application Publication No. 8-501291, or the like; a compound as described in Research Disclosure No. 24239; or a so-called fluorescent brightening agent, which is a compound that absorbs ultraviolet light and generates fluorescent light, typical examples being a stilbene or a benzoxazole compound.

An anti-fading agent is used in order to improve image conservation. For the anti-fading agent, it is possible to use various types of organic or metallic complex anti-fading agents. The organic anti-fading agent may be a hydroquinone, an alkoxyphenol, a dialkoxyphenol, a phenol, an aniline, an amine, an indane, a chromane, an alkoxyaniline, a heterocyclic compound, or the like, and a metallic complex anti-fading agent may be a nickel complex, a zinc complex, or the like. More specifically, it is possible to use a compound as described in the patents cited in Research Disclosure No. 17643, VII (I to J), No. 15162, No. 18716 (p. 650, the left-hand column), No. 36544 (p. 527), No. 307105 (p. 872), or No. 15162, or a compound included in the general formulae and examples of typical compounds described in pages 127 to 137 of Japanese Patent Application Publication No. 62-215272.

Examples of an anti-rusting agent are: sodium dehydroacetate, sodium benzoate, sodium pyridine thione-1-oxide, p-hydroxybenzoate ethyl ester, 1,2-benzisothiazoline-3-one, or a salt thereof, or the like. It is desirable to use these materials at a rate of 0.02 wt % to 1.00 wt % in the ink.

For the pH adjuster, it is possible to use the above-described neutralizing agent (an organic salt of inorganic alkali). In order to improve storage stability of the ink for the inkjet system, the pH adjuster is added desirably in such a manner that the ink reaches a pH of 6 to 10, and more desirably, in such a manner that the ink reaches a pH of 7 to 10.

The surface tension adjuster is, for example, a non-ionic, cationic, anionic or betaine surface active agent. In order that droplets of the ink can be ejected satisfactorily in the inkjet system, the added amount of the surface tension adjuster is, desirably, an amount which adjusts the surface tension of the ink to 20 mN/m to 60 mN/m, and more desirably, 20 mN/m to 45 mN/m, and even more desirably, 25 mN/m to 40 mN/m. Desirable examples of a surface active agent are: in a hydrocarbon system, an anionic surface active agent, such as a salt of a fatty acid, an alkyl sulfate ester salt, an alkyl benzene sulfonate salt, an alkyl naphthalene sulfonate, a dialkyl sulfosuccinate salt, an alkyl phosphate ester salt, a naphthalene sulfonate/formalin condensate, a polyoxyethylene alkyl sulfonate ester salt, or the like; or a non-ionic surface active agent, such as a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkyl amine, a glycerine fatty acid ester, oxyethylene oxypropylene block copolymer, and the like. Furthermore, it is also desirable to use SURFYNOLS (Air Products & Chemicals Co. Ltd.), which is an acetylene-based polyoxyethylene oxide surface active agent. Furthermore, an amine oxide type of amphoteric surface active agent, such as N,N-dimethyl-N-alkyl amine oxide, is also desirable. Moreover, it is also possible to use the surface active agents cited in pages 37 to 38 of Japanese Patent Application Publication No. 59-157636, and Research Disclosure No. 308119 (1989). Furthermore, it is also possible to use a fluorine (alkyl fluoride) type, or silicon type of surface active agent such as those described in Japanese Patent Application Publication No. 2003-322926, Japanese Patent Application Publication No. 2004-325707, and Japanese Patent Application Publication No. 2004-309806. It is also possible to use a surface tension adjuster of this kind as an anti-foaming agent; and a fluoride or silicone compound, or a chelating agent, such as EDTA, can also be used.

Moreover, desirably, the viscosity of ink for use in the inkjet system according to the embodiment of the present invention is 30 mPa·s or less. Furthermore, desirably, the viscosity is adjusted to 20 mPa·s or below.

As the aqueous medium, it is possible to use a mixed liquid having water as a main component, to which a water-miscible organic solvent is added as desired. Examples of the water-miscible organic solvent include: an alcohol (for example, methanol, ethanol, propanol, isopropanol, butanol, isobutanol, sec-butanol, t-butanol, pentanol, hexanol, cyclohexanol, or benzyl alcohol); a polyhydric alcohol (for example, ethylene glycol, diethylene glycol, triethylene glycol, polyethylene glycol, propylene glycol, dipropylene glycol, polypropylene glycol, butylene glycol, hexanediol, pentanediol, glycerine, hexanetriol, or thiodiglycol); a glycol derivative (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, or ethylene glycol monophenyl ether); an amine (for example, ethanolamine, diethanolamine, triethanolamine, N-methyl diethanolamine, N-ethyl diethanolamine, morpholine, N-ethyl morpholine, ethylene diamine, diethylene triamine, triethylene tetramine, polyethylene imine, or tetramethyl propylene diamine); and other polar solvents (for example, formamide, N,N-dimethyl formamide, N,N-dimethyl acetamide, dimethyl sulfoxide, sulfolane, 2-pyrrolidone, N-methyl-2-pyrrolidone, N-vinyl-2-pyrrolidone, 2-oxazolidinone, 1,3-dimethyl-2-imidazolidinone, acetonitrile, or acetone). It is also possible to use two or more types of the water-miscible organic solvents described above.

The ink for the inkjet system according to the embodiment of the present invention can be used for forming full-color images. In order to form a full-color image, it is possible to use a magenta-toned ink, a cyan-toned ink, and a yellow-toned ink; moreover, a black-toned ink may also be used in order to adjust the color tones. Furthermore, besides the yellow, magenta and cyan-toned inks, it is also possible to use red, green, blue or white inks, or so-called special colored inks used in the field of printing.

### Air/Liquid Separating Member

It is desirable to use a resin porous material as the material of the air/liquid separating member 29 provided inside the ink tank 15 according to the embodiment of the present invention. For example, it is suitable to use a porous member made of a fluorine resin, such a PTFE (polytetrafluoroethylene), polychlorotrifluoroethylene, tetrafluoroethylene hexafluoropropylene copolymer, tetrafluoroethylene perfluoroalkyl vinyl ether copolymer, tetrafluoroethylene ethylene copolymer, or the like. Fluorine resins have excellent air permeability and resistance to chemicals, and therefore, they are desirable materials for inkjet recording apparatuses which handle inks and treatment liquid. For the porous member, it is particularly suitable to use a thin-film material obtained by forming pores in a sheet of PTFE, for example, by means of a uniaxially stretching method or a diaxially stretching method. Furthermore, it is also desirable to use an inorganic porous material. Examples of this are ceramic or porcelain materials. Desirably, in order to improve the liquid-repelling characteristics with respect to the ink or treatment liquid, a liquid-repelling treatment agent is applied to the surface of the air/liquid separating member 29. It is possible to use an impregnation process or a spraying process for this treatment. Desirably, the liquid-repelling treatment agent is applied on the surface which makes contact with the ink, in particular, or on both this surface and the surface opposite to same. In order to display porous characteristics, it is desirable that the interiors of the holes should not be buried under the liquid-repelling agent during the liquid-repelling treatment process, and therefore, it is appropriate to carry out a high-pressure air blowing process, or a vacuum producing process, after carrying out the impregnation process or the spraying process. The liquid-repelling treatment agent displays liquid-repelling properties due to the fact that the polymer containing fluorine chains forms a skin having low surface free energy, on the surface of the material, and therefore, it is possible to use various types of polymers containing fluorine, as the liquid-repelling treatment agent. A polymer material containing a perfluoroalkyl group is preferable as this polymer containing fluorine.

If the ink stored inside the ink tank 15 contains a surfactant, then the liquid-repelling characteristics of the air/liquid separating member 29 formed from the material described above decline, and therefore it is either impossible to add any surfactant to the ink, or if it is added, the addable amount is severely limited.

### Recording Medium

As the recording medium 16 which can be used in the embodiment of the present invention, in addition to standard non-coated paper or coated paper, it is also possible to use various types of non-absorbent plastic or films of said plastic, as used in so-called packaging devices, and as the various types of plastic film, it is possible, for example, to cite polyethylene telephthalate (PET) film, oriented polystyrene (OPS) film, oriented polypropylene (OPP) film, oriented nylon (ONy) film, polyvinyl chloride (PVC) film, polyethylene (PE) film, or triacetyl cellulose (TAC) film. Other plastics may also be used, such as polycarbonate, acrylic resin, ABS, polyacetal, PVA, rubber, or the like. Furthermore, it is also possible to use a metal, a glass, or the like.

The surface energy of these various plastic films varies greatly depending on the characteristics of the base material, and in the prior art there has been a problem of changes in the dot diameter after deposition of the ink, depending on the type of recording medium. In the composition according to the embodiment of the present invention, it is possible to form satisfactory high-definition images on recording media having a surface energy in a range of 35 mN/m to 60 mN/m, including OPP film and OPS film, which have a low surface energy, and PET, which has a high surface energy.

Moreover, from the viewpoint of being able to respond to recording medium costs, such as packaging costs or production costs, print production efficiency, prints of various sizes, and the like, it is beneficial to use a long (web-feed) recording medium.

### EXAMPLES

Below, practical examples are described, but the present invention is not limited to these.

### Practical Example 1

In Practical Example 1, experimentation was carried out to investigate how the ink ejection characteristics are affected by the particle size distribution of the insoluble material contained in the ink, and the relationship between the surface tension of the ink and the surface free energy of the air/liquid separating member. The ink ejection characteristics were assessed by studying the amount of displacement in the ink depositing positions.

Four types of inks, namely, ink 1, ink 2, ink 3 and ink 4, were prepared, each having different particle diameter distribution densities (vol %) of the insoluble material in the ink composition ratios described below, and the particle size distribution of the ink was measured by means of a spectral particle size profiling apparatus, 10 days after the preparation.

(1) Manufacture of Ink

The inks have the following composition:

pigment (C.I. pigment red 122): 5 wt %;
styrene butadiene latex (average particle size 35 nm): 5 wt %;
styrene-acrylate-methacryl diethanolamine copolymer: 1 wt %;
benzyl methacrylate-(ethoxy(ethoxy(ethoxy(ethoxy)))) methacrylate-methacrylic acid: 1 wt %;
glycerine: 20 wt %;
diethylene glycol: 10 wt %;
non-ionic surfactant: 0.5 wt %;
2-pyrrolidone: 1 wt %; and
deionized water: remainder (to make up to 100 wt % in total).

Ink dispersion methods include, for instance, ball mills, sand mills, bead mills, high-pressure homogenizers, ultrasonic homogenizers and the like; in the embodiment of the present invention, using the ultrasonic homogenizer is the most appropriate method for manufacturing a dispersion such as the ink having a low coarse particle concentration with not more than 2 vol % of particles of 150 nm or larger. In the ultrasonic homogenizers, bubbles are created and destroyed in a solution by ultrasonic-induced cavitation, so that the shocks generated as a result allow crushing coarse particles present in the solution. The average particle diameter and the coarse particle content can be regulated by adjusting the ultrasonic irradiation time, the irradiation energy, or both. As the dispersant was used an ABC-type block copolymer of methacrylic acid (A), benzyl methacrylate (B) and ethoxytriethyleneglycol methacrylate (C) (mol ratio A:B:C=12:5:10). Herein, 30 g of the polymer, 10 g of a 45% aqueous solution of potassium hydroxide and 270 g of deionized water were mixed until homogeneous. Preliminary mixing was carried out by adding to the polymer, to be mixed therewith, 150 g of C.I. Pigment Red 122 and 550 g of deionized water, the resulting mixture being stirred for 30 minutes in a disperser. This preliminary mixture was subsequently charged in a double tank having an inner capacity of 2 liters; then, while being stirred with dispersing blades under cooling with water at 18° C., the preliminary mixture was subjected to batch irradiation of ultrasonic waves for 60 minutes, using a 36 mm chip, in an ultrasonic homogenizer US-1200 T (by Nissei Corp.). The four types of dispersions, namely, the ink 1, the ink 2, the ink 3 and the ink 4 were prepared herein by changing the oscillation amplitude and the energy density of the ultrasonic irradiation. Then, the inks were filtered with a filter having an average pore diameter of 0.45 μm (Minisart Syringe End Filters, by Sartorius Co.), to remove coarse particles. The inks were prepared in accordance with the foregoing method.

The particle size distribution of the ink manufactured with the aforementioned composition was measured with a particle size distribution profiler (a Nanotrac UPA-EX150 manufactured by Nikkiso Co., Ltd.). This particle size distribution profiler uses a measurement principle known as “dynamic light scattering”. If the particles have diameters of several micrometers or smaller, then a Brownian motion of the particles is produced, due to the effects of the movement of the solvent molecules. The speed of this motion varies with the size of the particles: the smaller the particles, the faster they move, and the larger the particles, the slower they move. When laser light is irradiated onto these particles in motion, scattering of different phases occurs in accordance with the speed of the particles, and when the scattered light is spectrally analyzed, a Doppler shift is obtained. In this way, the dynamic light scattering method determines the particle size distribution by calculating the Doppler-shifted particle size information. Measurements for the insoluble material were always carried out in transparent mode, for an aspherical shape. In order to measure the particle size distribution, since the optical density of the original ink liquid was too high to allow measurement, then the ink was diluted 1000 times by weight before measurement was carried out.

The surface tension of the ink was measured by means of the method already described above.

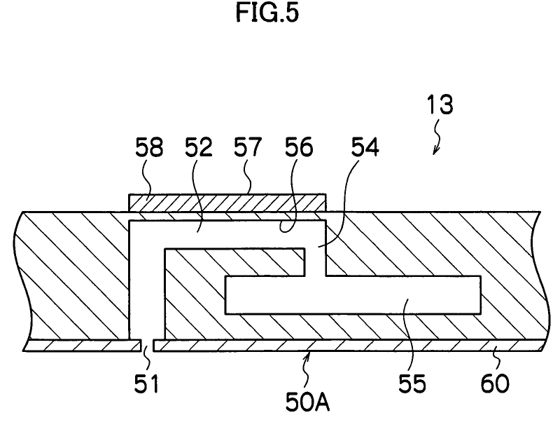

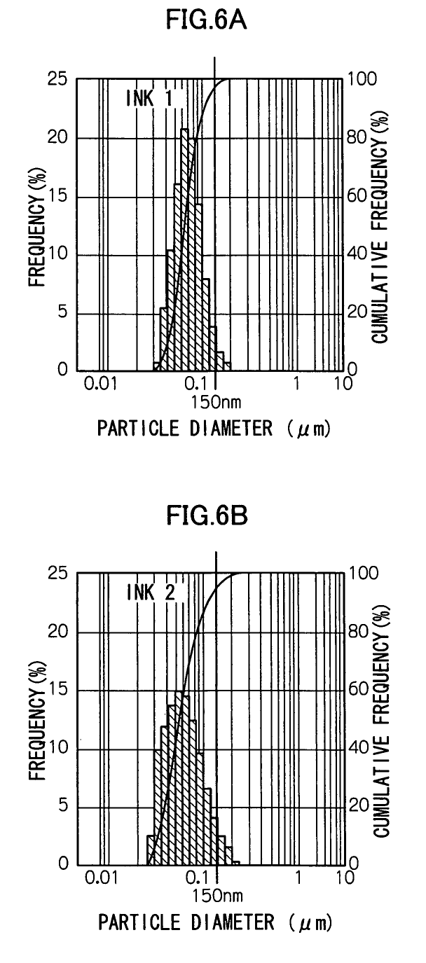

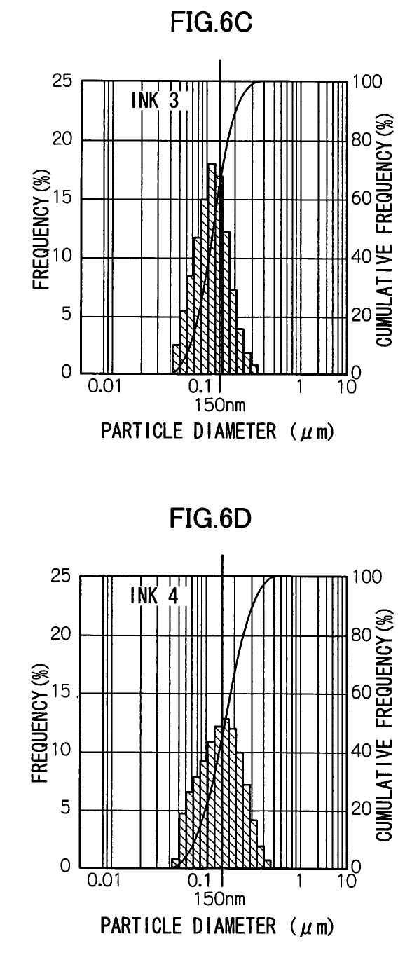

FIGS. 6A to 6D show the particle size distribution of the insoluble material contained in the ink 1 (FIG. 6A), the ink 2 (FIG. 6B), the ink 3 (FIG. 6C) and the ink 4 (FIG. 6D), as measured by the particle size distribution profiler described above. In FIGS. 6A to 6D, the thick line which is extended vertically is a line indicating a particle size of 0.15 μm (150 nm). As a result of this measurement, in the case of ink 1, the volumetric concentration of particles having diameters of 150 nm or above in the insoluble material contained in the ink was 2.2 vol %; in the case of ink 2, it was 5.1 vol %; in the case of ink 3, it was 25.5 vol %; and in the case of ink 4, it was 46.2 vol %. The surface tension of the ink was 28 mN/m for all of the inks 1 to 4.

The polymer particles added to the inks have preferably a film forming function. An acrylic latex (average particle diameter 30 nm) was added to the inks used in the present examples; the minimum film forming temperature (MFT) of this latex is 20° C., so that after printing, a latex film is formed through nipping by heated pressure rollers, to form on the recording medium a film with enhanced abrasion resistance, gloss, water resistance and weatherability. Although ink ejection characteristics are difficult to maintain in these inks over long periods of time, the scheme of the embodiment of the present invention allows preserving long-term film formation characteristics, and constitutes therefore a particularly preferable embodiment.

(2) Material of Air/Liquid Separating Member

The following four types of material were used as the material of the air/liquid separating member provided inside the ink tank. The four materials were: tetrafluoroethylene perfluoroalkyl vinyl ether copolymer, which has the surface free energy of 23.4 mN/m); polyimide (1), which has the surface free energy of 27.0 mN/m; polyvinylidene fluoride, which has the surface free energy of 31.6 mN/m; and polyimide (2), which has the surface free energy of 32.3 mN/m.

The surface free energy of the air/liquid separating member was measured by means of the method already described above.

(3) Method of Testing Displacement in Ink Depositing Positions

In order to observe the ink ejection characteristics in an initial state immediately after manufacture of the ink, for each of the four types of inks 1 to 4 described above, the inks were supplied by a pit stop method from the main tank 14 to the ink tank 15 of the ink cartridge 12, in a piezoelectric type of inkjet recording apparatus (5740 dpi×1440 dpi, liquid droplet volume: 1.5 pl), immediately after measuring the particle size distribution and the surface tension by means of the measurement methods described above. Ink droplets were ejected from the recording head 13 of the ink cartridge 12 onto a recording medium, which was special inkjet paper HK A4250 (“Kassai”, made by Fujifilm Corp.). Furthermore, the distance from the ink ejection ports of the recording head 13 to the recording medium was 0.5 mm. When the liquid droplets ejected from the recording head 13 exit from the nozzle outlets, they are propelled at a certain angle, and therefore in order to improve the ejection position accuracy, it is desirable that the distance from the ejection ports to the recording head should be smaller, since this improves the accuracy of the depositing positions. On the other hand, if the distance between the recording head 13 and the recording medium 16 is too short, then the recording medium 16 may make contact with the surface of the recording head, thus causing damage to the recording head 13. Consequently, it is desirable that the distance from the ink ejection ports of the recording head 13 to the recording medium 16 should be in the range of 0.5 mm to 1 mm. Moreover, desirably, the liquid volume of the ejected droplets in the range of 1 pl to 30 pl, the droplet ejection rate is in the range of 1 kHz to 40 kHz and the image resolution is 1200 dpi or above. In the ranges described above, the dots formed by the droplets are sufficiently small, and hence there is no grainy appearance, and even when forming a solid image, it is possible to create a solid image free of blank portions, by adopting sufficient dot overlap.

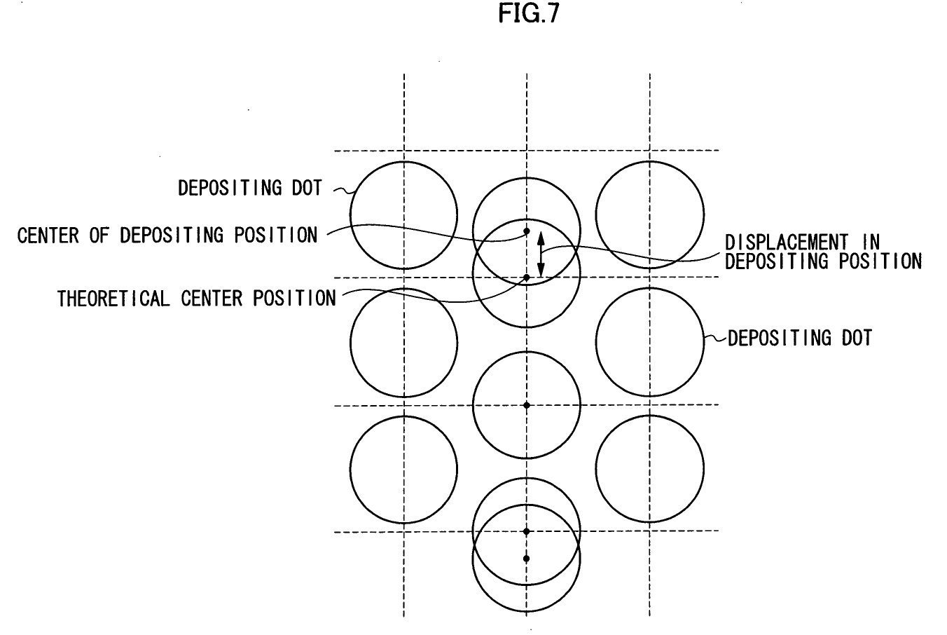

As shown in FIG. 7, the amount of displacement of the depositing positions (the distance between the theoretical center position of a deposited dot and the actual center of the depositing position as shown in FIG. 7) was measured, on the basis of the distance between the respective deposited dots in the print sample, and the nozzle pitch.

(4) Evaluation Criteria for Amount of Displacement in Depositing Positions

Here, as the evaluation criteria for the amount of displacement in the depositing positions, a displacement not less than 2 μm in the depositing position received the evaluation “unacceptable”, a displacement not less than 1.8 μm and not more than 2 μm received the evaluation “acceptable”, and a displacement of less than 1.8 μm received the evaluation “excellent”.

Here, the boundary between acceptance or unacceptance of the amount of displacement in the depositing positions was set at 2 μm because this value is the threshold value at which a human observer can perceive positional displacement with the naked eye; if the displacement exceeds 2 μm, then banding or striping can be perceived in the image with the naked eye, and therefore it is desirable to set the amount of displacement in the depositing position to be not more than 2 μm.

Advances are currently being made in raising image resolution and reducing the liquid droplet size in order to obtain high quality and high image resolution in an inkjet recording apparatus. In order to form solid images and to form line images, it is necessary to ensure a sufficient overlap between the dots. If sufficient dot overlap cannot be ensured, then this is visible as blank white regions in the image. When printing at 1200 dpi, the condition for overlapping between dots is that the dot diameter after landing should be approximately 30 μm. When printing at a droplet volume of 1.5 pl, the diameter of the liquid droplet after landing on the paper is approximately 25 μm to 35 μm, in the case of PM photographic paper (manufactured by Epson), Kassai (manufactured by Fujifilm), C2 paper (manufactured by Fuji Xerox), or Tokubishi Art (manufactured by Mitsubishi Paper Mills). A value of 2 μm for the displacement in the depositing position is a relatively high value, which is approximately 10% with respect to a dot diameter of 30 μm. Moreover, the higher the image resolution, the stricter the tolerances on positional displacement tend to become. When printing under current conditions of fine droplet size and high image resolution, the value of 2 μm or below for the displacement in the depositing position is a comparable criterion value for image quality.

When using a single pass printing method for inkjet recording, in which an image is recorded by conveying the paper only, without moving the recording head, it is particularly important that the amount of displacement in the depositing position should be kept to 2 μm or less, as stated previously. On the other hand, in a method where a recording head performs printing by a shuttle scanning action, then even if the amount of displacement of the depositing position exceeds 2 μm, since a split printing method is used, which makes the positional displacement of each particular nozzle difficult to perceive, then the positional displacement of individual dots is not liable to present a major problem.

(5) Test Results

### (5-1) Isolated Effects of Particle Size Distribution of Insoluble Material Only

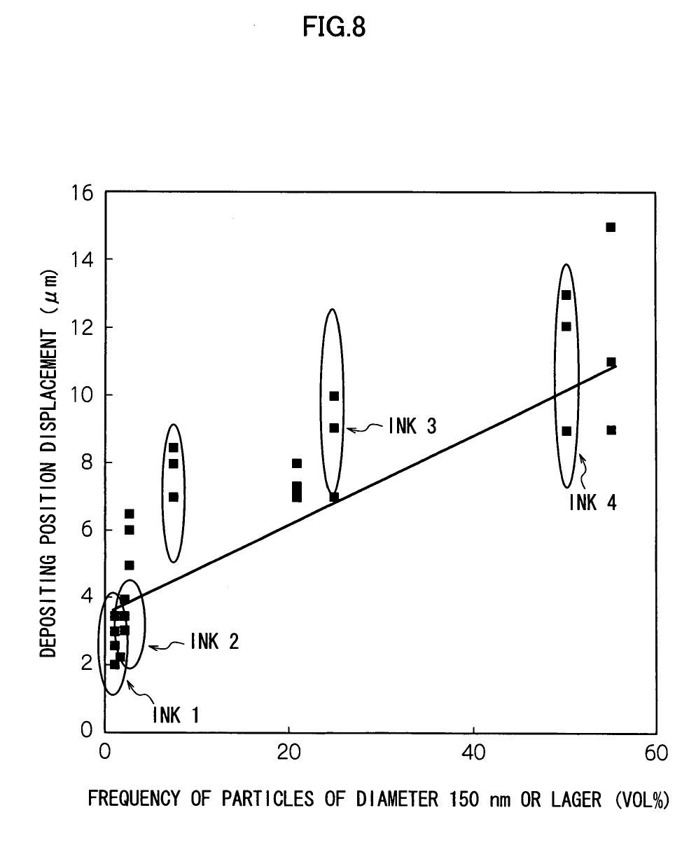

FIG. 8 shows the results of a study of the isolated effects of the particle size distribution of the insoluble material contained in the ink, where the four inks 1 to 4 were used with the air/liquid separating member made of tetrafluoroethylene perfluoroalkyl vinyl ether copolymer (having the surface free energy of 23.4 mN/m).

As a result, there was a very close relationship between the frequency (percent by volume) of particles having a particle size not smaller than 150 nm in the particle size distribution of the insoluble material contained in the ink, and the amount of displacement in the depositing positions. More specifically, there was a tendency for the amount of displacement of the depositing positions to become larger, and for the ink ejection characteristics to become worse, the greater the frequency of particles having a particle size not smaller than 150 nm in the particle size distribution of the insoluble material contained in the ink, in other words, in the order of the ink 1<the ink 2<the ink 3<the ink 4.

### (5-2) Initial Depositing Position Displacement Test

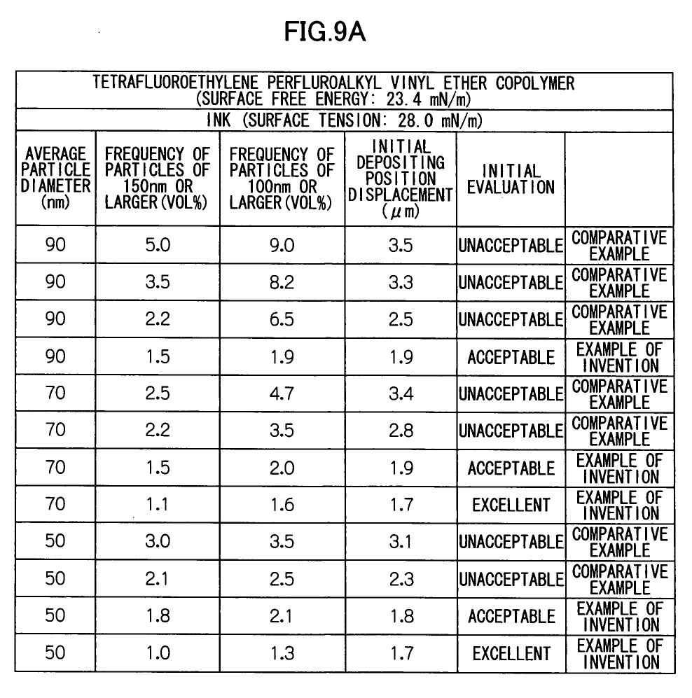

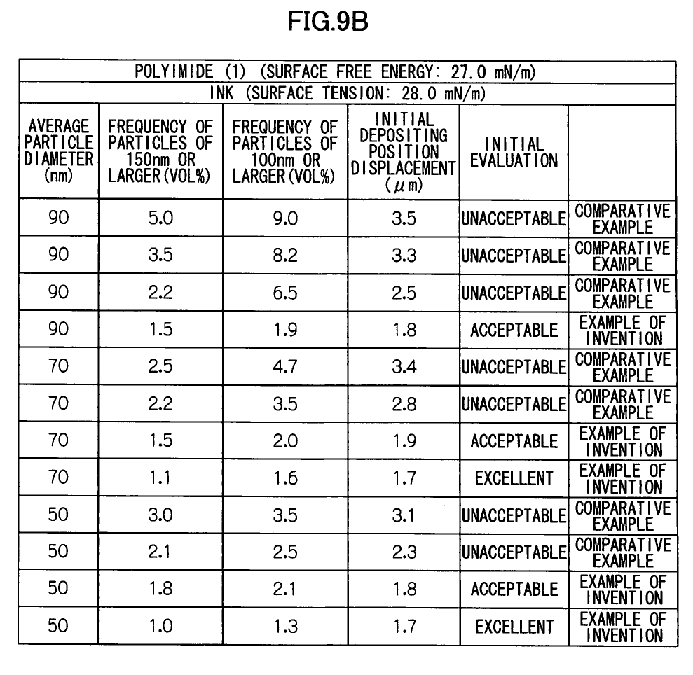

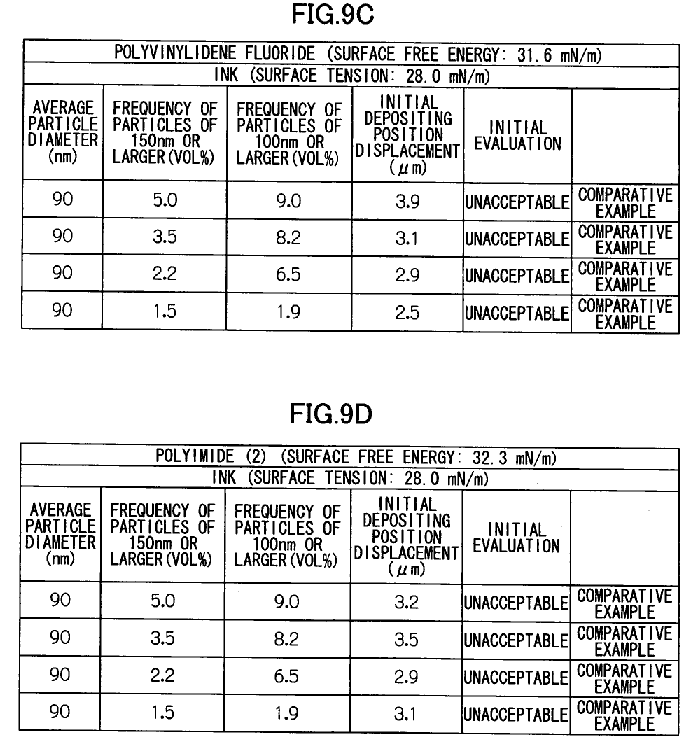

The tables in FIGS. 9A to 9D show the results of studying how the amount of displacement in the initial depositing positions was affected by the particle size distribution of the insoluble material contained in the ink, and the relationship between the surface tension of the ink and the surface free energy of the air/liquid separating member, which are the prerequisites of the embodiment of the present invention, using the testing method (3) described above.

As shown in FIGS. 9A to 9D, for each of three test categories of 90 nm, 70 nm and 50 nm average particle diameter of the insoluble material contained in the ink, the change in the amount of displacement of the depositing positions was studied with respect to change in the frequency of particles having diameters of 150 nm or larger in the particle size distribution of the insoluble material, and change in the relationship between the surface tension of the ink and the surface free energy of the air/liquid separating member. To investigate more rigorous conditions, a study was also made of the change in the amount of displacement of the depositing positions with change in the frequency of particles having diameters of 100 nm or larger in the particle size distribution of the insoluble material.

FIG. 9A shows a case where tetrafluoroethylene perfluroalkyl vinyl ether copolymer (having the surface free energy of 23.4 mN/m) was used as the material of the air/liquid separating member. This case satisfies the condition according to the embodiment of the present invention, which requires that the surface tension of the ink should be higher than the surface free energy of the air/liquid separating member.

FIG. 9B shows a case where the polyimide (1) (having the surface free energy of 27.0 mN/m) was used as the material of the air/liquid separating member. This case satisfies the condition according to the embodiment of the present invention, which requires that the surface tension of the ink should be higher than the surface free energy of the air/liquid separating member.

FIG. 9C shows a case where polyvinylidene fluoride (having the surface free energy of 31.6 mN/m) was used as the material of the air/liquid separating member. This case does not satisfy the condition according to the embodiment of the present invention, which requires that the surface tension of the ink should be higher than the surface free energy of the air/liquid separating member.

FIG. 9D shows a case where the polyimide (2) (having the surface free energy of 32.3 mN/m) was used as the material of the air/liquid separating member. This case does not satisfy the condition according to the embodiment of the present invention, which requires that the surface tension of the ink should be higher than the surface free energy of the air/liquid separating member.

In the test results described below, the requirement that “the frequency of particles having a particle size not smaller than 150 nm is not more than 2 vol % in the particle size distribution of the insoluble material contained in the ink” is referred to as the “particle size distribution condition”, and the requirement that “the surface tension of the ink is higher than the surface free energy of the air/liquid separating member” is referred to as the “surface tension condition”.

Consequently, as FIGS. 9A and 9B reveal, in each of the three test categories of 90 nm, 70 nm and 50 nm average particle size of the insoluble material, the practical examples that satisfy both the “particle size distribution condition” and the “surface tension condition” had assessments of “acceptable” or “excellent” for the initial amount of displacement in the depositing position, and hence the ink ejection characteristics were good.

On the other hand, in the case of the comparative examples that do not satisfy the “particle size distribution condition”, of the “particle size distribution condition” and the “surface tension condition”, the assessment of the initial amount of displacement of the depositing position was “unacceptable” in all cases, and hence the ink ejection characteristics were poor.

Furthermore, as FIGS. 9C and 9D reveal, in the case of the comparative examples that satisfy the “particle size distribution condition”, but do not satisfy the “surface tension condition” of the “particle size distribution condition” and the “surface tension condition”, the assessment of the initial amount of displacement of the depositing position was “unacceptable” in all cases, and hence the ink ejection characteristics were poor.

As these test results reveal, even in the case of the ink tank for the inkjet system in which the air/liquid separating member is provided inside the tank in which the ink is stored, in order to maintain stable ink ejection characteristics, in addition to using an ink formed by a dispersion of insoluble material dispersed in a solvent in which the material is insoluble, it is also necessary that the frequency of particles having a particle size not smaller than 150 nm should be not more than 2 vol % in the particle size distribution of the insoluble material, and that the surface tension of the ink should be higher than the surface free energy of the air/liquid separating member.

### (5-3) Depositing Position Displacement Test after Long-Term Storage

With respect to the inks of the practical examples that received the assessment of “acceptable” or “excellent” for the initial depositing position displacement shown in FIG. 9A, the amount of displacement of the depositing positions was studied after long-term storage of the inks, more specifically, after carrying out a compulsory storage test by loading the ink in a cartridge 12 and leaving the ink in a 60° C. environment for 20 days. The inkjet recording apparatus and the recording medium used here were the same as those described in the test method (3) above. The compulsory storage test is equivalent to a case where the ink is stored for a period of 8 months to 1 year in a normal environment (room temperature). The period was set to 8 months to 1 year since there is no practical problem for a person using the cartridge according to the embodiment of the present invention provided that the use period of the ink is 8 months or above. Furthermore, the “acceptable” and “excellent” verdicts in the assessment after the long-term storage are based on the same criteria as those used in the initial assessment.

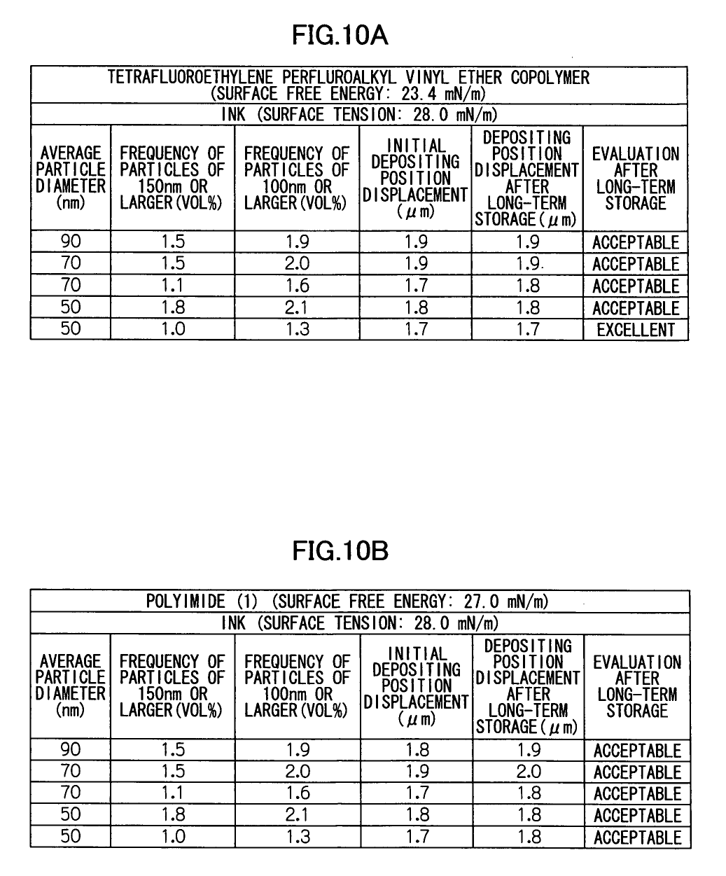

As a result of this measurement, as shown in the tables in FIGS. 10A and 10B, the displacement in the depositing positions of the ink after the compulsory storage test was slightly worse than the initial amount of displacement in the depositing position, but it was still not more than 2 μm, which is the criterion for acceptance or unacceptance. From this, it can be seen that stable ink ejection characteristics can be maintained over a long period of time, by satisfying both the “particle size distribution condition” and the “surface tension condition”.

Although the depositing position displacement test results for the comparative examples in FIG. 9A after long-term storage have not been shown here, in the ink of the comparative examples that had a high frequency of particles of large particle size, the average particle size and the frequency of particles of large particle size had both increased, when the particle size distribution was measured after storing for 20 days in a 60° C. environment after manufacture, thus reiterating the poor dispersion stability of the ink. It can be inferred that the particles of large size, which have poor dispersion stability, form aggregates, which have a detrimental effect on ink ejection characteristics and consequently cause an increase in the amount of displacement of the depositing position. The magnitude of the displacement of the depositing position is an important parameter which affects image quality, such as banding, and the target is to keep the amount of displacement of the depositing position to 2 μm or less.

### Practical Example 2

Practical example 2 investigated the relationship between the electrical conductivity of the ink and the dispersibility of the insoluble material. The ink 1 used in Practical example 1 was employed.

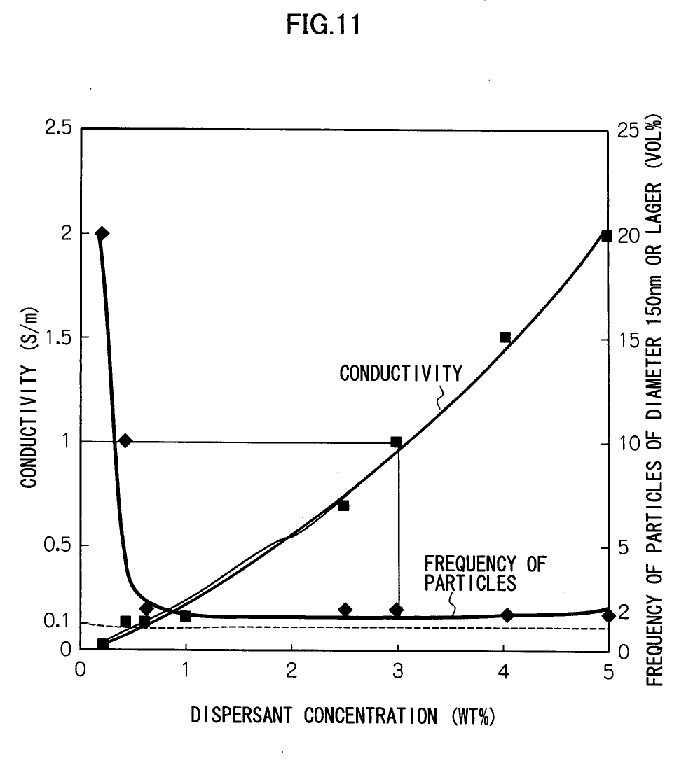

The conductivity of the ink 1 increases when the amount of benzyl methacrylate-(ethoxy(ethoxy(ethoxy(ethoxy)))) methacrylate-methacrylic acid, which is added as a dispersant, is raised. Therefore, a study was made of the change in the frequency of particles of insoluble material having diameters of 150 nm or larger, when the conductivity of the ink is changed by increasing the added amount of dispersant. The results of this are shown in FIG. 11.

As FIG. 11 shows, at a conductivity of 0.1 S/m or above, the frequency of particles of insoluble material having diameters of 150 nm or larger was 2 vol % or less, and hence the dispersion was good. However, if a large amount of dispersant is added, then a large amount of pH adjuster is required, and since stability declines over time, it is desirable to set an upper limit of 1 S/m for the conductivity. More specifically, the above-described ink has preferably the conductivity of 0.1 S/m to 1 S/m. By setting the conductivity of the ink to 0.1 S/m or above, it is possible to improve the dispersibility of the insoluble material contained in the ink, and thus to prevent the insoluble material from aggregating. This allows readily achieving, therefore, the condition of having a frequency of 2 vol % or less of particles having diameters of 150 nm or larger in the particle diameter distribution of the insoluble material. Furthermore, if a large amount of dispersant is added in order to raise the conductivity of the ink, a large amount of pH adjuster is required, and/or stability declines over time, and hence it is desirable to set an upper limit of 1 S/m for the conductivity.

It is preferable that the zeta potential of the insoluble material is +5 mV to +90 mV and the ink pH is adjusted to 2 to 7. Alternatively, it is also preferable that the zeta potential of the insoluble material is −5 mV to −90 mV and the ink pH is adjusted to 7 to 12. These conditions allow preventing the insoluble materials from aggregating through electrostatic forces, and allow further enhancing the dispersibility of the insoluble materials.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An ink tank assembly for an inkjet system, comprising:
a tank which contains an ink; and
an air/liquid separating member which is arranged in the tank, wherein:
the ink has a surface tension higher than a surface free energy of the air/liquid separating member;
the ink is a dispersion including a liquid and suspended particles of an insoluble material which is insoluble to the liquid; and
the insoluble material has a frequency of particles having diameters not smaller than 150 nm, of not more than 2% by volume in the insoluble material.

2. The ink tank assembly as defined in claim 1, wherein the insoluble material has a frequency of particles having diameters not smaller than 100 nm, of not more than 2% by volume in the insoluble material.

3. The ink tank assembly as defined in claim 1, wherein a concentration of the insoluble material is not less than 0.5% by weight and not more than 20% by weight in the ink.

4. The ink tank assembly as defined in claim 1, wherein the insoluble material includes pigment particles.

5. The ink tank assembly as defined in claim 4, wherein a grafted chain layer is introduced in a surface of each of the pigment particles.

6. The ink tank assembly as defined in claim 1, wherein the insoluble material includes polymer particles.

7. The ink tank assembly as defined in claim 6, wherein the polymer particles are made of a polymer which has a film forming function.

8. The ink tank assembly as defined in claim 6, wherein the polymer particles are made of a block polymer compound including polyethylene oxide.

9. The ink tank assembly as defined in claim 1, wherein the insoluble material includes a mixture of a plurality of types of particles which are each made of a plurality of types of material.

10. The ink tank assembly as defined in claim 1, wherein the insoluble material includes a type of composite particles which is made of a plurality of types of material.

11. An image forming apparatus, comprising the ink tank assembly as defined in claim 1.

12. The image forming apparatus as defined in claim 11, further comprising:
a recording head to which the ink is supplied from the ink tank assembly, the recording head outputting an image according to a printing signal; and
an ink absorbing member which is arranged in the tank and holds the ink by means of capillary action, wherein:
the tank has an air connection port which connects an interior of the tank with air; and
the air/liquid separating member is arranged in the tank at a position dividing the air connection port from the interior of the tank.

13. The image forming apparatus as defined in claim 12, further comprising a main tank, wherein:
the tank has an ink inlet port through which the tank is connected to the main tank to receive the ink; and
a pit stop type ink supply device which supplies the ink from the main tank to the tank by performing suction through the air connection port.
